(19) United States
(12) Patent Application Publication
(10) Pub. No.: US 2002/0087861 A1
(43) Pub. Date: Jul. 4, 2002

(54) Methods and systems for authenticating communications

(75) Inventors: Alon Segev, Mazkeret Batya (IL); Hod Lipson, Ithica, NY (US)

Correspondence Address: OLIFF & BERRIDGE, PLC, P.O. BOX 19928, ALEXANDRIA, VA, 22320, US

(73) Assignee: Nettrust Israel Ltd., Ramat Gan (IL)

(21) Appl. No.: 10/025,656

(22) Filed: Dec. 26, 2001

Related U.S. Application Data
(60) Provisional application No. 60/258,229, filed on Dec. 27, 2000.
(60) Provisional application No. 60/258,233, filed on Dec. 27, 2000.
(60) Provisional application No. 60/307,140, filed on Jul. 24, 2001.

(51) Int. Cl. H04L 9/00

(52) U.S. Cl. 713/168

(57) ABSTRACT

Provided are methods and systems for authenticating communications. An intermediary authenticates one or more communications by transferring communications and by storing information about the communications. The stored information at least includes times associated with the communications and at least part of the contents of the communications. The stored information may in some cases be later retrieved in order to provide authentication of the communications, for example in the case of a dispute involving one or more parties to the communications.

### FIELD AND BACKGROUND OF THE INVENTION

The present invention relates to authenticating communications, including, inter alia, electro-magnetically propagated communications.

Often, another party, if available, is called upon to provide an account of a face-to-face communication interaction between two or more parties. For example, in civil or criminal proceedings, the account of a witness as to the contents and time of the interaction may influence a judge or jury to accept or reject the version of one of the parties to the interaction.

Similarly, in the case of a message (oral communication) being transferred between parties by a messenger (another party), the messenger can serve as a witness to the contents and time of the message.

In both these cases, however, the other party when recalling the interaction or message, may fail to correctly recall the exact contents and time of the interaction/message due to memory problems, excessive processing (for example adding interpretation to the actual contents), etc.

In addition, the usage of a human messenger may compromise the desired privacy of the message.

Today, more and more communications between parties occur when the parties are not face-to-face. For example, parties may communicate by mail (for example, postal service or courier) or by electro-magnetically propagated communications (for example electronic or optical communications).

A telephone communication interaction (conversation) can be recorded by any of the parties to the conversation, under some legal constrains. However, the recording if made by a party of interest may be altered or arouse misgivings of having been altered.

When sending an envelope/package by mail, registered mail is often used when proof of delivery is required. A person at the address of the destination (not necessarily the expected recipient) signs to confirm receipt of a certain envelope/package at a specific time. In return receipt mail, the signed receipt is then returned to the address of the source (not necessarily received by the actual sender). Even assuming that the expected recipient at the destination acknowledges receiving the envelope/package, and the sender at the source acknowledges sending the envelope/package and/or receiving the signed receipt, the recipient can deny receiving specific contents in the envelope/package. Note that in signing the receipt at the destination, a person does not make any claim about the contents of the envelope/package, and therefore the recipient can later deny that specific contents were included in the signed-for envelope/package.

A proxy server acts as both a server system and client system during Internet communication exchanges. It is a server when accepting requests from browsers and acts as a client system when the browser software of the proxy server connects to he remote server. Some proxy servers keep a local copy of Internet documents for repeated access by clients within the local area network. The cached documents, however, are intended to be identical to the current version on the Internet and therefore can not be relied upon to reflect the contents of the documents during previous accesses (communications).

An email server may store copies of electronic mail (communications) received by and/or sent to the owner of the email account. The period of storage of the email, if not deleted by the owner of the email account, depends on the terms of the agreement between the server and the account owner. The stored electronic mail can usually be deleted at any time by the account owner without requiring permission of the other parties to the email communications. Therefore the account owner has more control over the storage period of the communications than the other parties to the communications.

In some electronic communications the time stated on the communication record can be easily altered. For example, the clock on the fax machine, answering machine, recorder, computer, etc. can be changed so that the communication record (such as tape recording, fax confirmation sheet, print-out of sent email or web page, etc.) reflects a different time than the real time of the communication.

Electronic signatures, RSA public and private keys, such as VeriSign, allow parties to sign and seal an electronic document. However, these methods do not provide a dating mechanism confirming when the signature came into existence. These methods also do not provide a mechanism to prove receipt of the signed document if the recipient is uncooperative.

Watermarking methods allow imprinting and adding information to digital documents, such as ownership information, in such a way that the information can not be separated from the original document and the original document can not be modified. This technology is aimed at protecting copyright and also does not provide a dating mechanism confirming when the is watermark actually came into existence. The technology also does not provide a mechanism to prove receipt of the watermarked document if the recipient is uncooperative.

Encryption technology allows sealing document contents so that it is accessible only to parties with appropriate keys. This technology protects the secrecy of the communication, but can not prove receipt (without the cooperation of the recipient) nor the time of the communication.

For electronic signature, watermarking and encryption technology, receipt may be proven if the recipient cooperates by actively acknowledging receipt of the communication, i.e. by returning a signed receipt including a signed copy of the entire original communication to the sender. However, the time of receipt can still be modified as explained above and in many cases the recipient may not have an incentive to acknowledge receipt, for example if the receipt of the communication may be detrimental to the recipient.

Several articles discuss the legal issues arising from electronic commerce. In an article “Moving with Change: Electronic Signature Legislation as a Vehicle for Advancing E commerce” by Thomas J. Smedinghoff and Ruth Hill Pro, originally published in The John Marshall Journal of Computer and Information Law, Vol XVII, No. 3, Spring 1999 at 723, the authors cite three fundamental legal issues when parties to a transaction use electronic records to replace paper, employ an electronic medium as the mode of communication and use electronic signatures to authenticate the transactions. The three issues are whether electronic documentation of transactions is legal, whether the electronic messages can be trusted, and what are the rules of conduct (for example, liability, cross-border recognition requirements, etc). Trusting a message requires consideration of the genuineness and integrity of the message and an assessment of whether the message is non-repudiable.

In the article “Digital Signature Risks” by Daniel B. Ritter & Mike Rodin, published in WSBA Bar News Mar. 1998, the author identifies the risks to evaluate when relying on a digital signature, including forgery, legal insufficiency, non-satisfaction of statute of frauds, certificate forgery, improper use of a private key, and increased difficulty of assigning an obligation evidenced by digital signed documentation.

In the article “Do we need new digital signature law” by Nicholas Baum the author cites some of the issues which can arise with digital signatures, such as the importance of witnessing a digital signature, responsibility if a digital signature is compromised, and the adequacy of checks performed by certifying authorities.

What is needed in the art are systems and methods for attesting to the contents and times of communications, as well as preferably the parties of communications. What is also needed in the art are systems and methods for attesting to the recipients of communications, without requiring active acknowledgement of receipt by the recipients. What is also needed in the art are systems and methods for attesting to electro-magnetically propagated communications.

### SUMMARY OF THE INVENTION

The invention provides for a method for authenticating electro-magnetically propagated communications, comprising the steps of:

an intermediary receiving at least one electromagnetically communication from at least one sender which is intended for at least one recipient;

said intermediary transferring said at least one communication to said at least one recipient; and

said intermediary storing a transcript including at least part of a content of said at least one communication and a time associated with said at least one communication;

wherein a period of said storing complies with at least one from a group including: permanent storing, storing for as long as required by law, and storing until cessation of storing as agreed upon by all said at least one sender and all said at least one recipient; and

wherein dung said period of said storing, said transcript can not be modified by any of said at least one sender nor by any of said at least one recipient

The invention further provides for a method for authenticating communications, comprising the steps of:

an intermediary receiving at least one communication from at least one sender which is intended for at least one recipient;

said intermediary transferring said at least one communication to said at least one recipient; and

said intermediary storing a transcript including at least part of a content of said at least one communication and a time associated with said at least one communication;

wherein a period of said storing complies with at least one from a group including: permanent storing, storing for as long as required by law, and storing until cessation of storing as agreed upon by all said at least one sender and all said at least one recipient; and

wherein during said period of said storing, said transcript can not be modified by any of said at least one sender nor by any of said at least one recipient.

Still further, the invention provides for a method for authenticating electro-magnetically propagated communications, comprising the steps of:

a trusted intermediary receiving at least one electro-magnetically communication from at least one sender which is intended for at least one recipient;

said intermediary transferring said at least one communication to said at least one recipient; and

said intermediary storing a transcript including at least part of a content of said at least one communication and a time associated with said at least one communication; said transcript being configured to serve as evidence in the case of a dispute involving at least one party from a group including: said at least one sender and said at least one recipient;

wherein a period of said storing compiles with at least one from a group including: permanent storing, storing for as long as required by law, and storing until cessation of storing as agreed upon by all said at least one sender and all said at least one recipient; and

wherein during said period of said storing, said transcript can not be modified by any of said at least one sender nor by any of said at least one recipient,

Yet further, the invention provides for a method for providing authentication of electro-magnetically propagated communications, comprising the steps of;

receiving an inquiry from an inquirer about at least one electro-magnetically propagated communication which involved a trusted intermediary;

retrieving a transcript stored by said intermediary, said transcript including at least part of a content of said at least one communication and a time associated with said at least one communication; and

transferring said transcript to said inquirer; wherein said transferred transcript is used as evidence in a dispute involving at least one party from a group including: at least one sender and at least one recipient of at least one of said at least one communication;

wherein said stored transcript was stored for a period complying with at least one from the group including: permanent storing, storing for as long as required by law, and storing until cessation of storing as agreed upon by all said at least one sender and all said at least one recipient, and wherein during said period of storing, said transcript could not be modified by any of said at least one sender nor by any of said at least one recipient.

The invention provides for a method for diverting electro-magnetically propagated communications for authentication, comprising the steps of:

a diverter receiving at least one electro-magnetically propagated communication from at least one sender which is intended for at least one recipient; and

said diverter transferring said at least one communication to an intermediary;

wherein said intermediary authenticates said at least one communication by an authenticating process including storing a transcript including at least part of a content of said at least one communication and a time associated with said at least one communication for a storing period complying with at least one from a group including: permanent storing, storing for as long as required by law, and storing until cessation of storing as agreed upon by all said at least one sender and all said at least one recipient, and wherein during said storing period said transcript can not be modified by any of sad at least one sender nor by any of said at least one recipient.

The invention provides for an apparatus for diverting electro-magnetically propagated communications for authentication comprising:

a replacer configured to replace locations of recipients or derivatives thereof with a location of an intermediary;

and a diverter relay configured to transfer electro-magnetically propagated communications for said recipients to said intermediary, in accordance with said replaced location;

wherein said intermediary authenticates said communications by an authenticating process including storing transcripts including at least part of contents of said communications and times associated with said communications for storing periods complying with at least one from a group including: permanent storing, storing for as long as required by law, and storing until cessation of storing as agreed upon by all senders and ail recipients of corresponding communications, and wherein during said storing periods said transcripts can not be modified by any of said senders nor by any of said recipients.

Still further, the invention provides for a system for authenticating electro-magnetically propagated communications, comprising:

a relay configured to transfer electro-magnetically propagated communications from senders to recipients;

a timestamp module configured to associate times with said communications; and

a storage configured to store transcripts including at least part of contents of said communications and said times associated with said communications, wherein said storage is configured to store each said transcripts for a storing period that complies with at least one from a group including; permanent storing, storing for as long as required by law, and storing until cessation of storing as agreed upon by all senders and all recipients of communications corresponding to said each said transcripts; and wherein said storage is configured to prevent said transcripts from being modified by said senders and said recipients during said storing period.

Yet further, the invention provides for a system for authenticating communications, comprising:

a relay configured to transfer communications from senders to recipients;

a timestamp module configured to associate times with said communications; and

a storage configured to store transcripts including at least part of contents of said communications and said times associated with said communications, wherein said storage is configured to store each said transcript for a storing period that complies with at least one from a group including: permanent storing, storing for as long as required by law, and storing until cessation of storing as agreed upon by all senders and all recipients of communications corresponding to said each said transcripts, and wherein said storage is configured to prevent said transcripts from being modified by said senders and said recipients during said storing period.

The invention provides for a system for authenticating electro-magnetically propagated communications, comprising:

a relay configured to transfer electro-magnetically propagated communications from senders to recipients;

a timestamp module configured to associate times with said communications; and

a storage configured to store transcripts including at least part of contents of said communications and said times associated with said communications, wherein said storage is configured to store each said transcripts for a storing period that complies with at least one from a group including: permanent storing, storing for as long as required by law, and storing until cessation of storing as agreed upon by all senders and all recipients of communications corresponding to said each said transcripts; and wherein said storage is configured to prevent said transcripts from being modified by said senders and said recipients during said storing period; said each said transcripts being configured to serve as evidence in the case of a dispute involving at least one party from a group including: said senders and said recipients of communications corresponding to said each said transcripts.

The invention further provides for a system for providing authentication of electro-magnetically propagated communications, comprising:

a storage configured to store transcripts prepared by a trusted intermediary for electro-magnetically propagated communications between senders and recipients, said transcripts including at least part of contents of said communications and times associated with said communications ; and

a customer service configured to receive requests from inquirers for particular communications, to retrieve corresponding transcripts from said storage and to transfer said transcripts to said inquirers, wherein said transferred transcripts are used as evidence in disputes involving at least one party from a group including: said senders and said recipients;

wherein said storage is configured to store each said transcripts for a storing period that complies with at least one from a group including: permanent storing, storing for as long as required by law, and storing until cessation of storing as agreed upon by all senders and all recipients of communications corresponding to said each said transcripts; and wherein said storage is configured to prevent said transcripts from being modified by said senders and said recipients during said storing period.

Still further, the invention provides for a system for authenticating electro-magnetically propagated communications, comprising;

at least one source/originator party;

at least one destination/auxiliary party; and

an intermediary

wherein said intermediary is configured to transfer electro-magnetically propagated communications between said at least one source/originator parties and said at least one destination/auxiliary party and to store transcripts of said transferred communications including at least part of contents of said transferred communications and times associated with said communications, each said transcripts being stored for a period complying with at least one from a group including; permanent storing, storing for as long as required by law, and storing until cessation of storing as agreed upon by all source/originator parties and all destination/auxiliary party associated with communications included in said each said transcripts, and wherein said transcripts can not be modified by any of said at least one source/originator party nor by any of said at least one destination/auxiliary party while stored; said each said transcripts being configured to serve as evidence in the case of a dispute involving at least one party from a group including; said senders and said recipients of communications corresponding to said each said transcripts.

Yet further, the invention provides for a system for authenticating communications, comprising:

at least one source/originator party;

at least one destination/auxiliary part;

an intermediary; and

at least one diverter between said at least one source/originator party and said intermediary, configured to divert communications for said at least one destinations/auxiliary parties from said at least one source/originator party to said intermediary,

wherein said intermediary is configured to transfer said communications between said at least one source/originator parties and said at least one destination/auxiliary party and to store transcripts of said transferred communications including at least part of contents of said transferred communications and times associated with said communications, each said transcripts being stored for a period complying with at least one from a group including: permanent storing, storing for as long as required by law, and storing until cessation of storing as agreed upon by all source/originator parties and all destination/auxiliary parties associated with communications included in said each said transcripts, and said transcripts can not be modified by any of said at least one source/originator party nor by any of said at least one destination/auxiliary party while stored; said each said transcripts being configured to serve as evidence in the case of a dispute involving at least one party from a group including: said senders and said recipients of communications corresponding to said each said transcripts.

The invention provides for a program storage device readable by machine, tangibly embodying a program of instructions executable by the machine to perform method steps for authenticating electro-magnetically propagated communications, comprising the steps of.

receiving at least one electro-magnetic communication from at least one sender which is intended for at least one recipient;

transferring said at least one communication to said at least one recipient; and

storing a transcript including at least part of a content of said at least one communication and a time associated with said at least one communications;

wherein a period of said storing complies with at least one from a group including: permanent storing, storing for as long as required by law, and storing until cessation of storing as agreed upon by all said at least one sender and all said at least one recipient; and

wherein during said period of said storing, said transcript can not be modified by any of said at least one sender nor by any of said at least one recipient.

The invention further provides for a computer program product comprising a computer useable medium having computer readable program code embodied therein for authenticating electro-magnetically propagated communications, the computer program product comprising:

computer readable program code for causing the computer to receive at least one electro-magnetically communication from at least one sender which is intended for at least one recipient;

computer readable program code for causing the computer to transfer said at least one communication to said at least one recipient; and

computer readable program code for causing the computer to store a transcript including at least part of a content of said at least one communication and a time associated with said at least one communication;

wherein a period of said storing complies with at least one from a group including: permanent storing, storing for as long as required by law, and storing until cessation of storing as agreed upon by all said at least one sender and all said at least one recipient; and

wherein during said period of said storing, said transcript can not be modified by any of said at least one sender nor by any of said at least one recipient.

Still further, the invention provides for a program storage device readable by machine, tangibly embodying a program of instructions executable by the machine to perform method steps for authenticating electro-magnetically propagated communications, comprising the steps of:

receiving at least one electro-magnetically communication from at least one sender which is intended for at least one recipient;

transferring said at least one communication to said at least one recipient; and

storing a transcript including at least part of a content of said at least one communication and a time associated with said at least one communication; said transcript being configured to serve as evidence in the case of a dispute involving at least one party from a group including: said at least one sender and said at least one recipient;

wherein a period of said storing complies with at least one from a group including: permanent storing, storing for as long as required by law, and storing until cessation of storing as agreed upon by all said at least one sender and all said at least one recipient; and

wherein during said period of said storing, said transcript can not be modified by any of said at least one sender nor by any of said at least one recipient.

Yet further, the invention provides for a computer program product comprising a computer useable medium having computer readable program code embodied therein for authenticating electro-magnetically propagated communications, the computer program product comprising.

computer readable program code for causing the computer to receive at least one electro-magnetically communication from at least one sender which is intended for at least one recipient;

computer readable program code for causing the computer to transfer said at least one communication to said at least one recipient; and computer readable program code for causing the computer to store a transcript including at least part of a content of said at least one communication and a time associated with said at least one communication; said transcript being configured to serve as evidence in the case of a dispute involving at least one party from a group including: said at least one sender and said at least one recipient;

wherein a period of said storing complies with at least one from a group including: permanent string, storing for as long as required by law, and storing until cessation of storing as agreed upon by all said at least one sender and all said at least one recipient; and

wherein during said period of said storing, said transcript can not be modified by any of said at least one sender nor by any of said at least one recipient.

The invention provides for a program storage device readable by machine, tangibly embodying a program of instructions executable by the machine to perform method steps for providing authentication of electro-magnetically propagated communications, comprising the steps of:

receiving an inquiry from an inquirer about at least one electro-magnetically propagated communication which involving a trusted intermediary;

retrieving a transcript stored by said intermediary, said transcript including at least part of a content of said at least one communication and a time associated with said at least one communication; and

transferring said transcript to said inquirer; wherein said transferred transcript is used as evidence in a dispute invoking at least one party from a group including: at least one sender and at least one recipient of at least one of said at least one communication;

wherein said stored transcript was stored for a period complying with at least one from the group including: permanent storing, storing for as long as required by law, and storing until cessation of storing as agreed upon by all said at least one sender and all said at least one recipient, and wherein during said period of storing, said transcript could not be modified by any of said at least one sender nor by any of said at least one recipient.

The invention further provides for a computer program product comprising a computer useable medium having computer readable program code embodied therein for providing authentication of electro-magnetically propagated communications, the computer program product comprising:

computer readable program code for causing the computer to receive an inquiry from an inquirer about at least one electro-magnetically propagated communication which involving a trusted intermediary;

computer readable program code for causing the computer to retrieve a transcript stored by said intermediary, said transcript including at least part of a content of said at least one communication and a time associated with said at least one communication; and

computer readable program code for causing the computer to transfer said transcript to said inquirer; wherein said transferred transcript is used as evidence in a dispute involving at least one party from a group including: at least one sender and at least one recipient of at least one of said at least one communication;

wherein said stored transcript was stored for a period complying with at least one from the group including: permanent storing, storing for as long as required by law, and storing until cessation of storing as agreed upon by all said at least one sender and all said at least one recipient, and wherein during said period of storing said transcript could not be modified by any of said at least one sender nor by any of said at least one recipient.

Yet further, the invention provides for a program storage device readable by machine, tangibly embodying a program of instructions executable by the machine to perform method steps for diving electro-magnetically propagated communications for authentication, comprising the steps of:

receiving at least one electromagnetically propagated communication from at least one sender which is intended for at least one recipient; and

transferring said at least one communication to an intermediary,

wherein said intermediary authenticates said at least one communication by an authenticating process including storing a transcript including at least part of a content of said at least one communication and a time associated with said at least one communication for a storing period complying w at least one from a group including: permanent storing, storing for as long as required by law, and storing until cessation of storing as agreed upon by all said at least one sender and all said at least one recipient, and wherein during said storing period said transcript can not be modified by any of said at least one sender nor by any of said at least one recipient.

The invention provides for a computer program product comprising a computer useable medium having computer readable program code embodied therein for diverting electro-magnetically propagated communications for authentication, the computer program product comprising;

computer readable program code for causing the computer to receive at least one electro-magnetically propagated communication from at least one sender which is intended for at least one recipient; and

computer readable program code for causing the computer to transfer said at least one communication to an intermediary;

wherein said intermediary authenticates said at least one communication by an authenticating process including storing a transcript including at least part of a content of said at least one communication and a time associated with said at least one communication for a storing period complying with at least one from a group including: permanent storing, storing for as long as required by law, and storing until cessation of storing as agreed upon by all said at least one sender and all said at least one recipient and wherein during said storing period said transcript can not be modified by any of said at least one sender nor by any of said at least one recipient.

### BRIEF DESCRIPTION OF THE DRAWINGS

The invention is herein described, by way of example only, with reference to the accompanying drawings, wherein:

FIG. 1a is a block diagram of a system for delivering communications using an intermediary, according to a preferred embodiment of the present invention;

FIG. 1b is a block diagram of a system for delivering communications using all intermediary, according to another preferred embodiment of the present invention;

FIG. 1c is a block diagram of a system for delivering communications using an intermediary, according to still another preferred embodiment of the present invention;

FIG. 2a is a flowchart of a method for authenticating communications, according to a preferred embodiment of the present invention;

FIG. 2b is a flowchart of a method for authenticating communications, according to another preferred embodiment of the present invention;

FIG. 3 is a flowchart of a method for providing authentication of communications, according to a preferred embodiment of the present invention;

FIG. 4 is a flowchart of a method for diverting communications for authentication, according to a preferred embodiment of the present invention;

FIG. 5 is a system for delivering mail via an intermediary, according to a preferred embodiment of the present invention;

FIG. 6 is a system for delivering faxes via an intermediary, according to a preferred embodiment of the present invention;

FIG. 7 is a system for an interactive phone communication via an intermediary, according to a preferred embodiment of the present invention

FIG. 8 is a system for delivering web pages via an intermediary, according to a preferred embodiment of the present invention;

FIG. 9 is a system for delivering electronic mail via an intermediary, according to a preferred embodiment of the present invention;

FIG. 10 is a system for delivering interactive web sequences via an intermediary, according to a preferred embodiment of the present invention; and

FIG. 11 is a system for delivering general data communications using the Ethernet and TCP/IP via an intermediary, according to a preferred embodiment of the present invention.

### DESCRIPTION OF THE PREFERRED EMBODIMENTS

A preferred embodiment of the invention uses an intermediary to authenticate a communication or a series of communications. Specifically, the intermediary is used to transfer a communication or series of communications and to create a script for that communication or series of communications.

In some cases, the usage of an intermediary to transfer of a communication(s) may make the party or parties trust the communication(s) more, treat the communication(s) with higher regard and/or pay more attention to the communication(s).

In some cases, for example if the intermediary does not involve human elements, privacy of the parties to the communication(s) and of the communication(s) is not compromised by the use of the intermediary.

In some cases the creation of a transcript by the intermediary may also serve as a convenience to the parties of a communication(s). For example, the storage of a communication(s) by the intermediary can relieve the parties to the communication(s) of filing requirements for communication records, return receipts etc, and the parties can later retrieve the stored communication(s) if necessary.

In some cases, even if the transcript is created by the intermediary but never presented, the fact that the party or parties to the one or more communications knows of the existence of the transcript, may serve as a deterrence to false claims regarding the communication(s).

In some cases, the transcript created by the intermediary can be presented in order to corroborate the claims of one or more of the part or parties to the communication(s), especially if the transcript qualifies as an “original” for evidentiary purposes. The transcript, including at least part of the content and time of the communication(s), may be viewed as reliable provided that the intermediary is viewed as trustworthy (see further below discussion of trust in intermediary). For example, in the case of conflicting claims as to the contents or time of a transferred document, the transcript of the document may substantiate the claims of the party asserting the same content as in the transcript of the intermediary. As another example, a party may send a communication describing his invention to himself via the intermediary, and the time and contents of the transcript may later be presented as proof of the date of the invention for intellectual property purposes.

In the discussion, the term “time” is used to connote a point in history which can be as broad or narrow as required or desired. The term “time” can include inter-alia any or all of the following: century, year, season, date, day of the week, hour, minute, second, etc.

The intermediary can be used when a communication is transferred in one direction (from a “source” to one or more “destinations”) or when a series of communications is transferred in more than one direction (between an “originator party” and one or more “auxiliary parties”, where the term “originator party” is used for the initiator of the communication interaction). More generally, the terms “senders” and “recipients” are utilized in the sense that a single communication (separate or within a series) derives from a sender and is directed to one or more recipients. Although in the description the terms “source”, “destination”, “originator party”, “auxiliary party”, “sender” and “recipient” sometimes refer to inanimate objects (hardware, firmware, software, building, etc.) from or to which a communication is communicated, it will be understood that the ultimate source, destination, originator party, auxiliary party, sender or recipient is the user (i.e. the individual or collection of individuals for example in a business entity) who uses those inanimate objects. Therefore, in the description and the appended claims the terms “source”, “destination”, “originator party”, “auxiliary party”, “sender” and “recipient” are used interchangeably to refer to the inanimate objects and/or the users thereof as appropriate.

The usage of an intermediary when transferring a series of communications between multiple parties (i.e. the originator party and auxiliary parties) occurring in series or in parallel may allow the establishment of a clearer context and intent of the communications, which may not be readily observable from examining the individual communications in isolation (i.e. separately).

The principles and operation of an intermediary for communications according to the present invention may be better understood with reference to the drawings and the accompanying description. Throughout the discussion many examples are given for illustration purposes. All examples unless stated otherwise should be viewed as non-limiting.

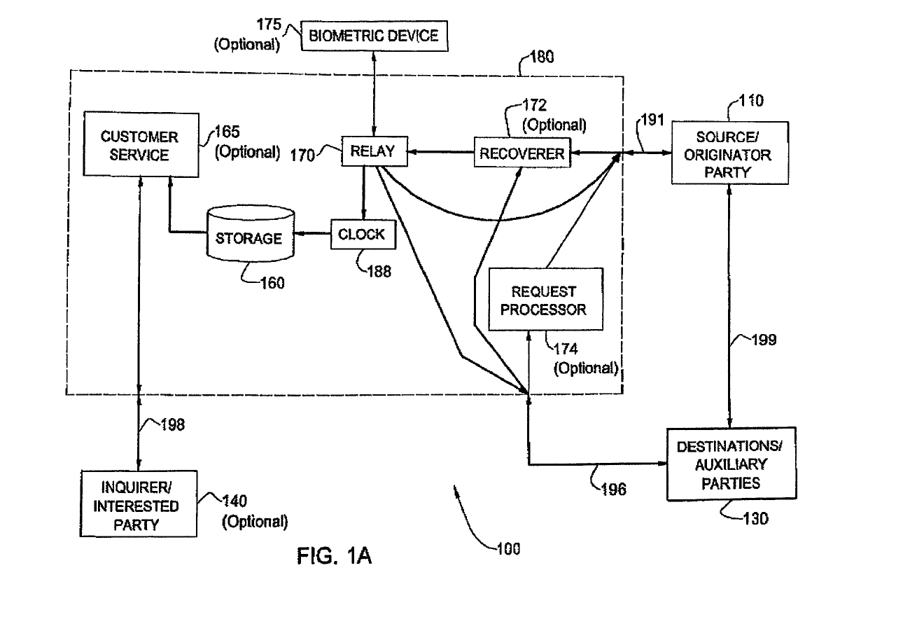

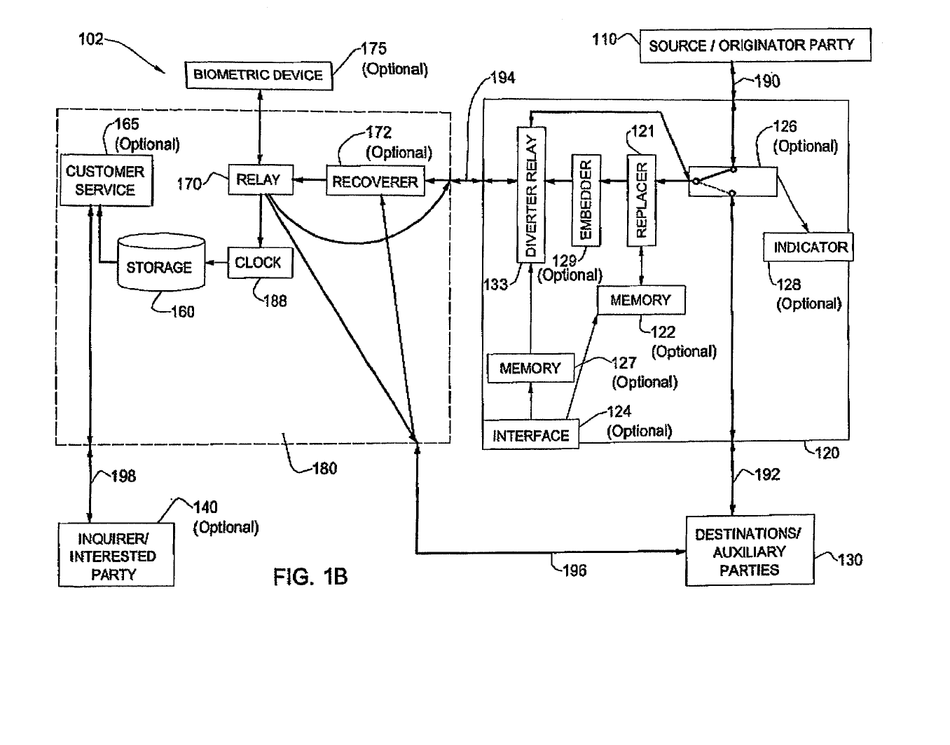

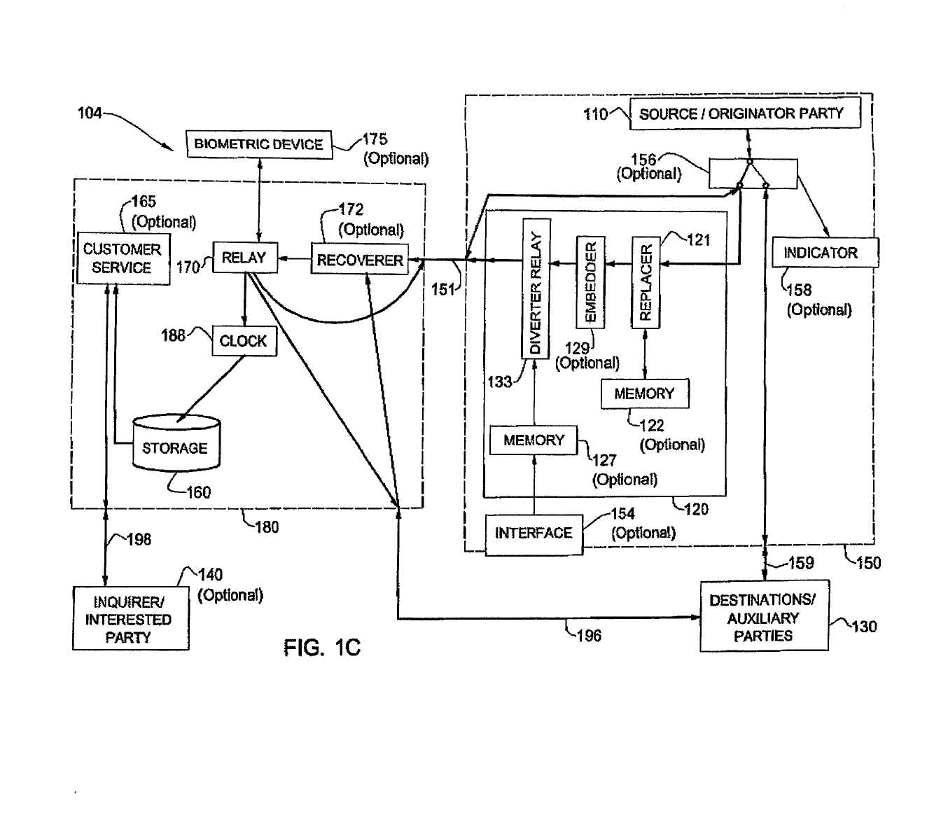

Referring now to the drawings, FIGS. 1a, 1b and 1c illustrate systems 100, 102 and 104 for involving an intermediary 180 in communications between a source/originator party 110 and one or more destinations/auxiliary parties 130, according to preferred embodiments of the present invention. Identical numbers in figures 1a, 1b, and 1c connote elements with identical functions. It should be evident that the systems of the current invention are not bound by the configurations of the components and/or makeup of the components shown in FIGS. 1a , 1b, and 1c.

Hereinbelow for ease of presentation, the plural terms destinations, auxiliary parties, and recipients are used to connote one or more destinations, auxiliary parties, and recipients, respectively but it should be evident that for a particular communication or series of communications there may be a single destination, auxiliary party and recipient, respectively. In some preferred embodiments, source/originator party 110 and destination/one of auxiliary parties 130 may be identical (i.e. at least partially self-communication), and in other preferred embodiments source/originator party 110 and all destinations/auxiliary parties are different.

FIG. 1a illustrates a preferred embodiment (system 100) without a diverter 120 for transferring communications. In some cases, intermediary 180 may first request a particular communication from source 110 following a request from destination 130 to intermediary 180. In other cases, source/originator party 110 may send the communication directly to intermediary 180 without a prior request.

In the preferred embodiments 102 and 104 shown in FIGS. 1b and 1c, a diverter 120 is included. In these preferred embodiments, diverter 120 diverts communications intended for destinations/auxiliary parties 130 to intermediary 180 Therefore source/initiator party 110. From the point of view of (how to reach) intermediary 180 because diverter 120 contacts intermediary 180 in the place of source/initiator party 110. From the point of view of source/originator party 110, it preferably appears is as if source/originator party 110 contacted destinations/auxiliary parties 130 directly and normally.

FIG. 1b illustrates a preferred embodiment with diverter 120 separate from source/originator party 110. FIG. 1c illustrates a preferred embodiment with diverter 120 and source/originator party 220 in common unit 150. As an example of a shared unit 150, diverter 120 and source/originator party 110 may be part of the same software program 150, or two interrelated software programs in a common machine 150 for executing the program(s), such as a computer, PDA, etc. As another example of a shared unit 150, diverter 120 and source/originator party 110 may be interconnected by hardwire in a common unit 150 such as a telephone, fax machine, etc.

Systems 100, 102 and 104 optionally also include an inquirer/interested party 140 as will be explained further below.

Depending on the preferred embodiment 102, 104 and/or 106, one or more communication networks 151, 159, 190, 191, 192, 194, 196, 198, and 199 connect source/originator party 110, diverter 120, unit 150, destinations/auxiliary parties 130, intermediary 180, and/or inquirer 140. For a particular communication or series of communication, the same communication network may or may not be used for transferring the communication(s) all the way from the sender 110 or 130 to recipients 110 and/or 130. For example, in many cases, intermediary 180 may prefer to use the same communication network to receive and send a particular communication. As another example, communication networks 151 and 159 may be identical and/or 194 and 192 may be identical. In order to not confuse the drawings only one communication network is shown between each two elements in FIGS. 1a, 1b, and 1c for both directions of transfer of communications, confirmations, and/or requests. However it should be evident that in some preferred embodiments of the invention each direction may use a different type of communication network. In addition, if more than one destination/auxiliary party 130 is a party to a particular communication, each of the destinations/auxiliary parties 130 may use a different type of communication network to communicate with other parts of system 102, 104 or 106.

Depending on the preferred embodiment, communication networks 151, 159, 190, 191, 192, 194, 196, 198 and 199 can represent any combination of physical communication medium with any application protocol. Examples of physical media include, inter-alia: cable, optical (fiber), wireless (radio frequency), wireless (microwave), wireless (infra-red), twisted pair, coaxial, telephone wires, underwater acoustic waves, mail transportation (truck, plane, human), etc. Examples of application protocols include File Transfer Protocol (FTP), Telnet, Simple Mail Transfer Protocol (SMTP), Hyper Text Transport Protocol (HTTP), Simple Network Management Protocol (SNMP), Network News Transport Protocol (NNTP), Audio (MP3, WAV, AIFF, Analog), Video (MPEG, AVI, Quicktime, RM), Fax(Class 1, Class 2, Class 2.0), mail (postal service or courier), tele/video conferencing etc. In some preferred embodiments, communication networks 151, 159, 190, 191, 192, 194, 196, 198 and 199 can alternatively or in addition to be identified by the middle layers, with examples including the data link layer (modem, RS232, Ethernet PPP point to point protocol, serial line internet protocol-SLIP, etc), network layer (Internet Protocol-IP, User Datagram Protocol-UDP, address resolution protocol-ARP, telephone number, caller ID, etc.), transport layer (TCP, Smalltalk, etc), session layer (sockets, Secure Sockets Layer-SSL, etc), and/or presentation layer (floating points, bits, integers, HTML, XML, etc). For example the term “Internet” is often used to refer to a TCP/IP network Envisioned future protocols for communication networks include haptics, smell, taste, 3D video, etc.

For preferred embodiments with optical communication networks, systems 100, 102 and 104 may also include a special light modulator (SLM-not shown).

The protocol used for specifying the location of (i.e. way to reach) source/originator party 110, destinations/auxiliary parties 130, inquirer/interested party 140 or intermediary 180 depends on the communication network used. In general, any network identification, used for any network layer, (i.e. any protocol specific identifier) can serve to specify the location. Examples of location include: email address, mail address, post office box, fax number, telephone number, Internet Protocol (IP), URL (uniform resource locator), Smalltalk address, Ethernet address, and caller identification (ID). It is also possible that other forms of identification can be used to specify source/originator party 110, destinations/auxiliary parties 130, inquirer/interested party 140 or intermediary 180 and using a lookup table, a corresponding protocol specific identifier (location) can be retrieved. (In other words, locations and other forms of identification can be derived from one another) Examples of other forms of identification include: client identification, name, diverter identification, passwords, biometric identification, etc.

It is preferable tat the specified location for source/originator party 110 and/or destinations/auxiliary parties 130 is the official location of the source/originator party 110 and/or destinations/auxiliary parties 130 respectively. The term official is used in the sense of the formal location for all communications associated with the professional function of source/originator party 110 and/or destinations/auxiliary parties 130 (for example the business address as opposed to the home address). It should be evident that more than one protocol can be used to identify the same location of source/originator part 110, destinations/auxiliary parties 130, inquirer/interested party 140 or intermediary 180. For example many places of business can be reached though a mail address, email address, fax number, telephone number, and URL,

Darker lines in FIGS. 1a , 1b, and 1c connote possible flows of communications (possibly among flows of other signals) according to some preferred embodiments of the invention.

In FIG. 1a , communications requiring transfer by intermediary 180 flow from source/originator party 110 via communication network 191 to intermediary 180 and then to destinations/auxiliary parties 130 via communication network 196. Optional communications in the reverse direction flow from one auxiliary party 130 to intermediary 180 via network 196 and then to originator party 110 via network 191 and/or other auxiliary parties via network 196. Optional confirmations of correct communications flow from recipients 110 and/or 130 to intermediary 180 via network 191 and/or 196. Optional confirmations of authenticating process flow from intermediary 180 to source/originator party 110 via network 191 and/or to destinations/auxiliary parties 130 via network 196. Optional requests for communications flow from destinations/auxiliary parties 130 to intermediary 180 (via network 196) and then to source/originator party 110 (via network 191). Communications not requiring transfer by intermediary 180 flow between source/originator party 110 and destinations/auxiliary parties 130 via network 199.

In FIG. 1b, communications requiring transfer by intermediary 180 flow from source originator party 110 to diverter 120 via communication network 190, then to intermediary 180 via communication network 194 and then to destinations/auxiliary parties 130 via communication network 196. Optionally communications in the reverse direction flow from one auxiliary party 130 to intermediary 180 via network 196 and then to diverter 120 via network 194 and originator party 110 via network 190 and/or to other auxiliary parties via network 196. Optional confirmations of correct communications flow from recipients 110 and/or 130 to intermediary 180 via network 190 and 194 and/or 196. Optional confirmations of authenticating process flow from intermediary 180 to diverter 120 via network 194 and then to source/originator party 110 via network 190 and/or to destinations/auxiliary parties 130 via network 196. Communications not requiring transfer by intermediary 180 flow between source/originator party 110 and destinations/auxiliary parties 130 via diverter 120 and networks 190 and 192.

In FIG. 1c , communications requiring transfer by intermediary 180 flow from unit 150 to intermediary 180 via communication network 151 and then to destinations/auxiliary parties 130 via communication network 196. Optionally communications in the reverse direction flow from one auxiliary party 130 to intermediary 180 via network 196 and then to unit 150 via network 151 and/or to other auxiliary parties via network 196. Optional confirmations of correct communications flow from recipients 110 and/or 130 to intermediary 180 via network 151 and/or 196. Optional confirmations of authenticating process flow from intermediary 180 to unit 150 via network 151 and/or to destinations/auxiliary parties 130 via network 196. Communications not requiring transfer by intermediary 180 flow between unit 150 and destinations/auxiliary parties 130 via network 159.

In FIGS. 1a, 1b, and 1c, communications (included in a transcript) optionally flow from intermediary 180 to inquirer/interested party 140 via a communication network 198. Inquiries for transcripts optionally flow from inquirer 140 to intermediary 180 via network 198.

Functional elements of intermediary 180 and diverter 120 will now be expanded upon.

Intermediary 180 includes a relay 170 for transferring communications between source/originator party 110 and destination/auxiliary parties 130 and for conveying copies of the communications to storage once relay 170 is satisfied that correct transfer has occurred. Communications received by relay 170 are transferred to communication networks 191/194/151 and/or network 196 for transmission to recipients 110 and/or 130. In addition to transferring communications for transmission, relay 170 may establishes connections, if necessary (see below), between originator party 110 and auxiliary parties 130. Relay 170 also, when necessary, receives/determines location or other identification information on source/originator party 110 and/or destinations/auxiliary parties 130.

Optionally, relay 170 also requests, receives, and or verifies passwords and/or biometric identification. Alternatively instead of performing the verification, relay 170 may optionally send received biometric identification to an optional biometric device 175 for verification processing and may receive the results of the verification processing from that biometric device 175.

Optionally relay 170 may also assign a transaction number to a particular communication(s) and/or a tracker to a series of communications. Relay 170 may also optionally mark transferred communications as discussed below. Relay 170 may also optionally send confirmations to and/or receive confirmations from source/originator party 110 and/or destination/auxiliary parties 130, and/or send notices of intended communications to recipients 110/130.

Intermediary 180 also includes a clock 188 for time-stamping the time of a particular communication(s). In addition, intermediary 180 includes a storage 160, for example a database if the storage is electronic, for storing a transcript of a particular communication(s). The transcript includes, possibly along with other information, at least part of the content of the communication(s) and time of the communication(s).

Optionally intermediary 180 includes a customer service 165 for retrieving the transcript from storage 160 for presentation to an inquirer/interested party 140, possibly following receipt of an inquiry from inquirer 140. Inquirer/interested party 140 can be for example, source/originator party 110, destinations/auxiliary parties 130, the law, etc. Customer service 165 can also optionally send information regarding stored communications to interested party 140 periodically or under certain conditions.

Intermediary 180 also optionally includes a recoverer 172, for example a parser, for recovering the location of recipients 110 and/or 130 embedded in a particular communication, in preferred embodiments where the location of recipients 110 and/or 130 is embedded in communications. If recoverer 172 is included, communications received by intermediary 180 are first processed by recoverer 172 if necessary and then passed to relay 170.

In addition, intermediary 180 optionally includes a request processor 174 for processing a request from destination 130 that intermediary 180 contact source 110 and ask for a specific communication.

It should also be evident that the functions of intermediary 180 are separated into the elements illustrated in FIGS. 1a, 1band 1c for convenience of explanation. The elements can be implemented using any combination of software, hardware, firmware, objects, people, etc. For example, intermediary 180 can be a server. As another example, intermediary 180 can include clerks, photocopiers, time stamps, file cabinets and federal express service for receiving/sending communications. In other preferred embodiments, the functions of intermediary 180 may be grouped into fewer or more elements with broader or narrower functions. It should also be evident that elements of intermediary 180 may be concentrated in one physical location or spread out among more than one physical location. For example, in some preferred embodiments involving telephone conference calls, the transfer and/or connection establishing functions of intermediary 180 may be performed at a public telephone exchange while all other functions of intermediary 180 may be performed at a different location. As another example, the storage function may be provided at more than one physical location.

As noted above, systems 102 and 104 include a diverter 120. One of the differences between the preferred embodiments 102 and 104 of FIGS. 1band 1c is that in preferred embodiment 102, communications intended for source/originator party 110 may need to pass through diverter 120 (without significant effect) because diverter 120 may be in line between communication network 194 leading from intermediary 180 to source/originator party 110 and/or in line between communication network 192 leading from destinations/auxiliary parties 130 to source/originator party 110. In contrast, in preferred embodiment 104, communications intended for source/originator party 110 may enter unit 150 and be transferred directly to the part of unit 150 which functions as source/originator party 110 (without passing tough the part which funtions as diverter 120). Also in preferred embodiment 102, elements which interface with a user (for example an optional indicator 128, an optional interface 124 and an optional switch 126) may be included in diverter 120. In contrast in preferred embodiment 104, elements which interface with a user (for example an optional indicator 158, an optional interface 154 and an optional switch 156) are included in unit 150 and not necessarily in the part of unit 150 functioning as diverter 120.

Diverter 120 includes a replacer 121 for replacing the location of destinations/auxiliary parties 130 with the location of intermediary 180 so as to divert communications to intermediary 180.

In some preferred embodiments, diverter 120 may also include optional memory 122, accessible to replacer 121, for storing the location of one or more intermediaries 180 to which communications are to be diverted. Optional memory 122 may alternatively or also be used by replacer 121 for storing the replaced location of destination/auxiliary parties 130 until the location can be sent to intermediary 180 (for example by diverter relay 133) or for a different length of time. An example for when storing the location of more than one intermediary 180 may be necessary is if communications from different sources/originator parties 110 which are connected to diverter 120 are diverted to different intermediaries 180. In this example memory 122 includes the locations of the different intermediaries which are provided to replacer 121 depending on source/originator party 110 of the communication. Alternatively, in other preferred embodiments, memory 122 may not be needed to store the location of intermediary 180 if the location of intermediary 180 is included with each communication from source/originator party 110.

Diverter 120 also includes diverter relay 133 which is responsible for transferring communications and any other related information (such as source/destination information) to communication network 151 or 194 for transmission to intermediary 180. In some preferred embodiments where diverter 120 is a separate unit in line with source/originator party 110, diverter relay 133 is also responsible for relaying incoming communications from communication network 194 to source/originator part 110 (through network 190).

In some preferred embodiments, diverter 120 has a unique identification, to stored in optional memory 127. In some of these preferred embodiments, diverter 120 includes an optional interface port 124, or unit 150 includes an optional interface port 154, for reprogramming the unique identification in memory 127. In some of these preferred embodiments, the unique identification is accessed by diverter relay 133 and transmitted to intermediary 180 with some or all communications. The unique identification can replace the source/originator party identification determined by diverter relay 133 from source/originator party 110 and become the source/originator party identification sent to and processed by intermediary 180 in these preferred embodiments.

In some preferred embodiments including diverts 120, the same or a different interface port 124/154 may optionally be included in diverter 120/unit 150 for testing diverter 120 and/or reprogramming optional memory 122,

In some preferred embodiments, the contents of optional memory 122 and/or 127 can be reprogrammed remotely via a communication network for example via network 194 or 151.

In some preferred embodiments, diverter 120 includes an optional embedder 129 for embedding the location of destinations/auxiliary parties 130 in communications transferred to intermediary 180. In these preferred embodiments, embedder 129 may receive the location of a particular destinations/auxiliary parties 130 from replacer 121, embed the location in a particular communication and transfer the communication to diverter relay 133 for transfer to intermediary 180. In other preferred embodiments with no embedder 129 in diverter 120, the location of destination 130 is received by diverter relay 133 from replacer 121 and transferred to communication network 194/151 separately from (i.e. not embedded in) the communications

In some preferred embodiments, diverter 120 includes an optional switch 126, or unit 150 includes an optional switch 156 for providing a mode of operation, i.e. diversion of communications to intermediary 180 or passing communications to destinations/auxiliary parties 130 via communication network 159/192. If no switch 126/156 is included, or if the setting of switch 126/156 is the default setting, communications are in some preferred embodiments diverted to intermediary 180.

In some preferred embodiments including diverter 120, diverter 120 or unit 150 includes an optional indicator or indicators 128/158 for indicating when a diversion to intermediary 180 is in progress and/or switch 126/156 is set for diversion. Indication can be by sound, visual cues or other means.

It should be evident that the functions of diverter 120/unit 150 are separated into the elements illustrated in FIGS. 1a , 1b, and 1c for convenience of explanation. The elements can be implemented using any combination of software, hardware, firmware, objects, people, etc. As an example diverter 120 can be a hardware “black” box. As another example, diverter 120 can be software. As another example diverter 120 can include a person, a writing implement to add the address of intermediary 180 and mail service. In other embodiments, the functions of diverter 120/unit 150 may be grouped into fewer or more elements with broader or narrower functions. It should also be evident that elements of divert 120/unit 150 may be concentrated in one physical location or spread out among more than one physical location.

It should also be evident that the one to one correspondence of source/originator party 110, diverter 120 inquirer/interested party 140, and intermediary 180 shown in embodiments 100, 102 and 104 is for simplicity of the drawings. In preferred embodiments, each diverter 120 may service a single or a plurality of sources/originator parties 110. In general a single intermediary 180 services a plurality of sources/originator parties 110, inquirer/interested party 140, and/or diverters 120.

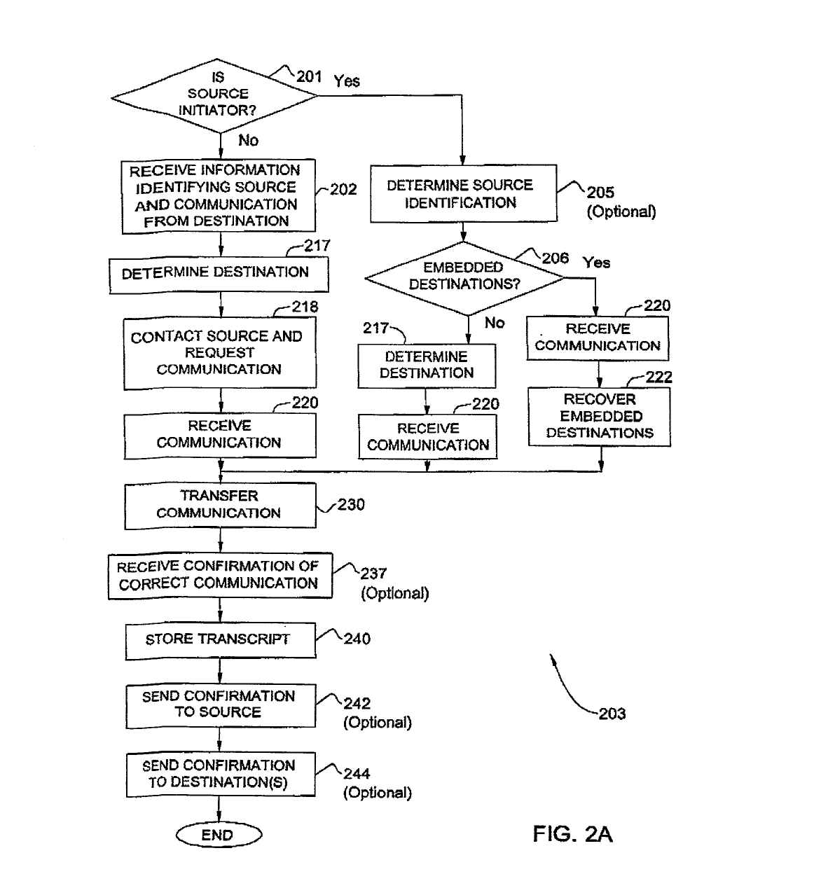

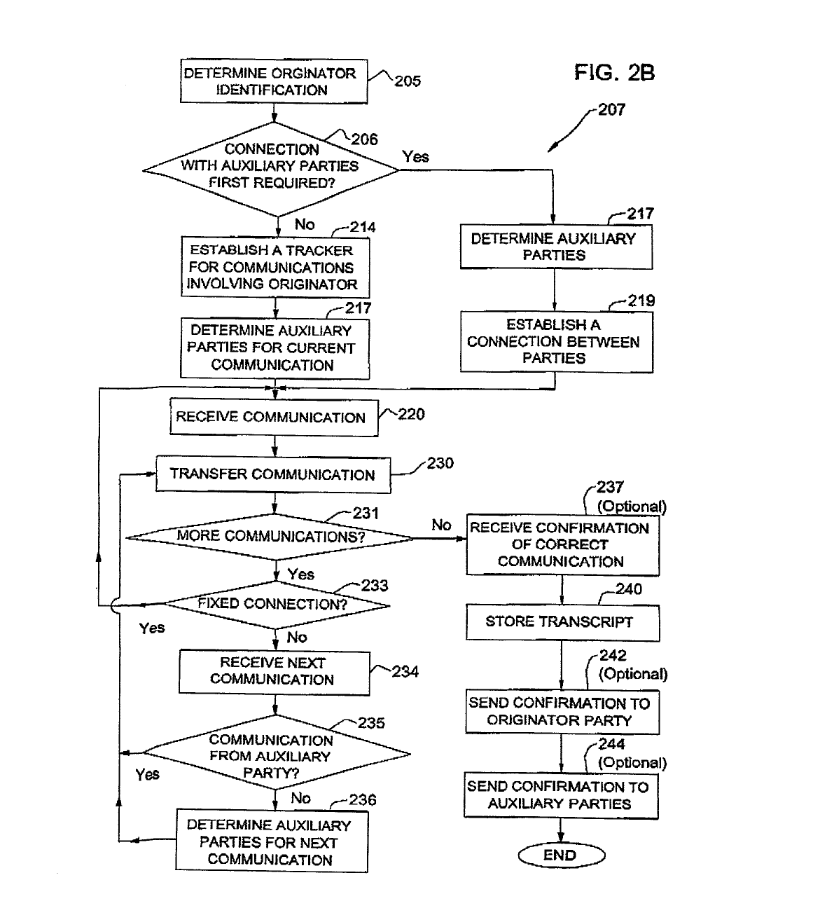

FIG. 2a and 2b show preferred embodiments 203 and 207 of methods for authenticating communications, as practiced by intermediary 180. Preferred embodiments 203 are for a communication in one direction and preferred embodiments 207 are for a series of communications in more than one direction. It should be evident that the order of steps in FIGS. 2a and 2b are for convenience of presentation and may be altered depending on the preferred embodiment. Corresponding steps in illustrated preferred embodiments 203 and 207 are given identical numbers.

Preferred embodiments based on FIGS. 2a and 2b include three main steps. In step 220, intermediary 180 receives a communication which is intended for destinations 130 or alternatively parties 110 and/or 130. The communication which arrives at intermediary 180 is transferred (forwarded) by intermediary 180 to destinations 130 or alternatively to parties 130 and/or 110 in step 230. In step 240 a transcript of the communication(s) is stored.

It should be noted that in preferred embodiments based on FIGS. 2a and 2b, intermediary 180 takes an active role in the transfer of the communications. Therefore, in cases where the transcript stored by intermediary 180 is used as evidence in a dispute involving parties to the communications (senders and/or recipients) and possibly other parties, it is assumed that the transcript may carry additional testimonial weight due to the active role performed by intermediary 180. As an example of when other parties (that are not party to the communications) may be parties to the dispute, the stored transcript of the communications an inventor sends to himself describing his invention may be used in a dispute with another person who claims to have been the first to invent. For the purposes of the description, disputes include but are not limited to legal proceedings, for example civil actions, criminal actions, administrative actions, etc. Such disputes are assumed to be settled by an entity which is authorized to settle disputes by law and/or by contract (agreement) between the parties to the dispute, including but not limited to court, arbitration, etc, or such disputes are assumed to be settled by the parties to the dispute themselves. The term “by law” hereinbelow includes by a given section of the law, by regulation, or by court decision.

In the preferred embodiments 203 illustrated in FIG. 2a, either source 110 or destination 130 can initiate the contact with intermediary 180. If destination 130 initiates the contact, in step 202 intermediary 180 receives information from destination 130 identifying source 110 and the desired communication (as an example the URL of a desired web page). Through this contact, intermediary 180 determines the location of destination 130 (shown here as step 217). Intermediary 180 then contacts source 110 and requests the desired communication in step 218. The communication is then received in step 220.

If source 110 (either directly or through diverter 120) initiates the contact with intermediary 180, the method begins with step 205 with the optional determination by intermediary 180 of the source identification. Step 205 may in some embodiments not be performed for example if intermediary 180 dues not store a source identification and has no other need to know source 110. If the location(s) of destinations 130 is embedded in the communication the communication is received in step 220 and in step 222 intermediary 180 recovers the location. If the location(s) of destinations 130 is not embedded in the communication, in step 217, intermediary 180 determines the location of destinations 130. The communication is received in step 220.

The communication is transferred to destinations 130 in step 230. Optionally, intermediary 180 waits to receive confirmation from destinations 130 that the communication is the correct communication in step 237, prior to storage of the transcripts. The confirmation can be required, for example, if destination 130 initiated the contact with intermediary 180 and therefore source 110 is not able to verify the communication and so destination 130 needs to verify the communication. The transcript is then stored in step 240. Optionally a confirmation is sent to source 110 in step 242. Optionally a confirmation is sent to destinations 130 in step 244.

In the preferred embodiments 207 illustrated in FIG. 2b, the method begins with intermediary 180 determining the identification of originator part 110 (as mentioned above in the case of multi-direction communication, the term originator party 110 is used for the initiator of the communication interaction). If a connection between originator party 110 and auxiliary parties 130 is necessary prior to the start of the communication interaction, intermediary 180 determines the locations of auxiliary parties 130 in step 217 and contacts the auxiliary parties in step 219 so as to establish the connection. If not, intermediary 180 assigns a tracker in step 214 for identifying communications involving originator party 110, and in step 217 intermediary 180 determines the locations of auxiliary parties 130 for the first communication. The tracker can be for example a session identification. The first communication is received by intermediary 180 in step 220 from an originator party 110 (either directly or through diverter 120) or an auxiliary party 130. Intermediary 180 transfers the received communication to recipients 110 and/or 130 in step 230.

The connection is termed in the discussion “fixed” if throughout the series of communications while the connection is established only communications generated by the same auxiliary parties 130 and originator party 110 can travel via that connection.

If transfer of more communications is desired and the connection is fixed, the process iterates to step 220 for the receipt of the next communication. If the connection is not fixed then the next communication is received in step 234 and in step 235 the sender 110 or 130 of the communication is determined. If the sender is an auxiliary part 130, the process iterates to step 230. In some cases communications from one auxiliary party 130 may be transferred to other auxiliary parties 130 in addition to originator party 110.

If the sender is originator part 110, then the location of auxiliary parties 130 is determined in step 236 (for example by being received) and the process iterates to step 230. It should be evident that during the communication transfer, in some cases the tracker established in step 214 is used to identify a communication so that intermediary 180 knows how to properly transfer the communication. For example, the tracker may allow intermediary 180 to forward communications from auxiliary parties 130 to originator party 110 which arc received in response to communications from originator party 110 to auxiliary parties 130.

Although not shown in FIG. 2b so as to not complicate the drawing, in some cases the location of recipients 110 and/or 130 of one or more of the series of communications may be embedded in the communication and in these cases, intermediary 180 recovers the embedded location of recipients 110 and/or 130 (sometimes instead of performing step 217 and/or 236).

Once transfer of communications is completed, the process continues with the optional step 237 of receiving confirmation of correct communications (from originator party 110 and/or auxiliary parties 130). The transcript is then stored in step 240. Optionally, a confirmation is sent to originator party 110 in step 242 and/or to auxiliary parties 130 in step 244

It should be pointed out that in some cases, a specific interaction can be represented by either preferred embodiment 203 and 207, i.e. be considered either a series of two communications or a request for a communication and the actual communication. For example, if a user is requesting a web page (communication), the request could also be considered the first of two communications with the web server. If the interaction is considered a series of two communications then the stored transcript may in some cases include both communications. On the other hand if the interaction is considered a request and a communication, the stored transcript may in some cases only include the communication (in this example, the retrieved web page).

In some preferred embodiments, the transfer of the communication or series of communications through intermediary 180 may be transparent to source/originator party 110 and/or destination/auxiliary parties 130. In other preferred embodiments, the usage of intermediary 180 may be indicated on the transferred communication and/or sent confirmations, for example “delivered through an intermediary”, “sender identification confirmed”, etc.

Step 205 in preferred embodiments 203 and 207 refer to intermediary 180 determining source/originator party identification and step 235 in preferred embodiment 207 refers to determination of sender identification. The determined identification can be for example the location of the source/coriginator party or sender, respectively (see above for examples of locations). The determined identification can alternatively or in addition be another form of identification for example: the diverter identification, client identification, name, password, biometric identification, etc.

Intermediary 180 can determine the identification of source/originator party/sender, for example, if the source/originator party/sender identification is explicitly received (directly or indirectly through diverter 120) from source/originator party 110 or from sender 110 or 130, or if the source/originator party/sender identification can be inferred (for example using caller ID). As mentioned above, the identification of party 110 determined by intermediary 180 may in some cases related to diverter 120 as in the cases when diverter 120 sends a diverter identification as source/originator party identification to intermediary 180.

Step 217 in preferred embodiment 203 and 207 and step 236 in preferred embodiment 207 refer to determining the location of destinations/auxiliary parties 130. In some eases the location of destinations/auxiliary parties 130 may be received and in some cases the location of destinations/auxiliary parties 130 may be determined without being received, for example if all communications involving a specific source/originating party 110 always involve the same destinations/auxiliary parties 130. As another example, another form of identification may be received and the corresponding location determined, for example using a lookup table.

Note that steps 217 and 236 refer to locations whereas steps 205 and 235 refer to identification which may or may not be locations. In some cases where no communications/confirmations are to be transferred to source/originating party/sender then the location of source/originating party/sender may not need to be known. An identification of some type however may in some of these cases need to be known for authenticating the communications.

It should be evident that different types of identification may provide different levels of certainty with regard to identity. Note tat the actual sender may not always be identical to the expected sender, and the actual recipients may not always be identical to the expected recipients. For example, a person other than the expected sender may have access to the telephone number, fax number, email address, etc of the expected sender, and/or people other than the expected recipients may have access to the telephone number, fax number, email address, etc of the expected recipients. An example of when a high level of certainty with regard to the identity of a recipient may be required is if a communication is confidential. As example of when a high level of certainty with regard to the identity of a sender may be required is if the communication includes a pledge. In these types of cases, a higher level of certainty with is regard to the identity of the sender/recipient can be established, for example, by passwords (for example identification numbers) and/or other biometric means such as an electronic signature, digital signatures (including VeriSign), retina fingerprint handprint, biometric signature, voice signature, other signature, etc.

For example in some preferred embodiments, intermediary 180, may only accept communications from a sender if a password and/or other biometric identification is received and verified. This added protection can be implemented for example, by requiring receipt and verification of a password/biometric identification prior to step 220. In some preferred embodiments, intermediary 180 may tell recipients of an intended communication but only forward the communication if recipients are identified by a password and/or other biometric means. This added protection can be implemented by adding to the methods of FIGS. 2a and 2b prior to step 230 the steps of having intermediary 180 transmit a notice of intended communication to recipients 110/130 and receiving in return a password/biometric identification from the recipients.

For a series of communications where connection between parties 110 and 130 is required prior to interaction, intermediary 180 may in some preferred embodiments only establish the connection (step 219) if passwords/biometric identification of sender and/or recipients are first received by intermediary 180. For any series of communications, intermediary 180 may in some preferred embodiments require password/biometric identification of sender and/or recipients prior to the receipt and/or transfer of the first of the series of communications, for each of the series of communications, or periodically during the series of communications.

In some preferred embodiments the communication(s) are encrypted (for example by sender 110 or 130 or by intermediary 180) to provide additional protection in case of a breach in communication or storage security.

In the preferred embodiments 203 and 207, storage 240 of the transcript in storage 160 takes place once intermediary 180 (for example relay component 170) is satisfied that the communication reached destinations 130 or the series of communication reached recipients 110/130. Depending on the preferred embodiment, intermediary 180 may deem that the communication reached destinations 130 or the series reached recipients 110/130 based on different standards. For example, in some preferred embodiments, intermediary 180 may deem the communication to have reached destinations 130 or the series to have reached recipients 110/130 if a technical confirmation is received (for example electronic handshake of fax machine or email server). As another example in other preferred embodiments, call back receiving may be required, i.e. intermediary 180 notifies the expected recipient of a communication and the recipient must call back and provide a password to receive the communication, and only then is the communication deemed to have reached destinations 130 or recipients 110/130. As another example, for a fixed connection step 240 may be performed once all parties 110 and 130 are disconnected.

The transcript stored may reflect the final stage of the communication(s) or may be of interim stages of the communication(s), depending on the preferred embodiment For example when dealing with web contracts, it may be preferable to create a transcript of not only the final web document but also the sequence of events that led to the final web document, such as for example the entire session, in order to establish intent.

Depending on the preferred embodiment the transcript stored in storage 160 may include the entire flow of the communication(s) (i.e. the entire content) or may include specific milestones of the communications (i.e. party of the contents).

As an example of a case where it may be desirable to only store specific points in the communication, consider for example a telephone transaction such as paying the electricity bill. An electricity client may only wish to have intermediary 180 record, for example, the meter number, amount paid, date, and transaction number, and not, for example, the preliminary greetings by the electricity company.

The stamped (associated) time in the transcript can be as pinpointed as necessary for a specific communication(s). For a single communication the stamped (associated) time is preferably the time of delivery of the communication to destination 130 but may in some preferred embodiments be the time of receipt of the communication(s) by intermediary 180 (from source 110, possibly via diverter 120). When the transcript includes a series of communications, the stamped (associated) time can relate to the beginning of the series (for example the time of receipt or delivery by intermediary 180 of the first communication and/or the time of the establishment of the connection), the end of the series (for example the time of receipt or delivery by intermediary 180 of the last communication and/or the time of disconnection), and/or each or some of the communications in the series.

Preferably, along with the time and the content, for each communication or each series of communications, the transcript also includes an identification of source/originator party 110 and/or of destinations/auxiliary parties 130 which may or may not be identical to the determined identification of source/originator party 110 and/or determined/recovered location (or identification) of destinations/auxiliary parties 130. For example, intermediary 180 may have a lookup table (not shown) listing locations and corresponding names of businesses/persons so that using the determined locations for parties 110 or 130, intermediary 180 retrieves the corresponding names from the lookup table and stores those names in the transcript. In some cases the stored identification of parties 110 and/or 130 include password and/or other biometric identification.

In some preferred embodiments in addition to, or instead of the identification of source/originator party 110 and/or destinations/auxiliary parties 130, a transaction number assigned by intermediary 180 is stored as part of the transcript. (The transaction number could have been assigned for example as part of step 230 or 240). In these preferred embodiments, the transaction number may also be given to source/originator party 110, for example in step 242, and/or to destinations/auxiliary parties 130, for example in step 230 or step 244.

In some preferred embodiments in addition to, or instead of the identification of source/originator party 110 and/or destinations/auxiliary parties 130, the tracker assigned by intermediary 180 in step 214 is stored as part of the transcript. In these preferred embodiments, the tracker may also be given to source/originator party 110, for example in step 242, and/or to destinations/auxiliary parties 130, for example in step 230 or step 244.

In preferred embodiments where it is desired that transcripts can serve as evidence in the case of a dispute involving parties to the communications included in the transcripts (senders and/or recipients) and possibly other parties, all information available to intermediary 180 is preferably stored. It is also required in these preferred embodiments that the contents of the original communication(s) received by intermediary 180 are not modified by intermediary 180, so that a faithful original may be stored. For example, in some of these preferred embodiments the transcripts can include: 100% of the original contents of the communication(s), the associated time, all identification and/or location information available on source/originator party 110, and destinations/auxiliary parties 130.

In some preferred embodiments, instead of storing as an indication that identification was satisfactorily established the actual identification of source/originator party 110, destinations/auxiliary parties 130, intermediary 180 may store another indication that identification was satisfactorily established with any or all of source/originator party 110, and destinations/auxiliary parties 130,. For example intermediary 180 may store as another indication, a “yes” that identification was satisfactorily established along with the means/criteria used to establish the identification.

In some preferred embodiments, an indication is also stored that a particular communication or series of communications was probably or definitely processed (e.g. read, heard, viewed) by recipients 110 and/or 130. For example, the transcript may include an indication tat a delivered email was opened, an indication of the existence of a reply communication referring to the particular communication, an indication that a fixed connection was maintained during the delivery of the particular communication, etc.

Each stored transcript for a communication or series of communications may be kept depending on the preferred embodiment or the particular transcript permanently, as required by law, or until cessation of storage as agreed upon by all parties 110 and 130 to the communication or series of communications. Depending on the preferred embodiment or the particular transcript, all parties 110 and 130 may have need in advance (prior to storing) when to cease storage, or all parties 110 and 130 may agree at any time during the storage period to cease storage (delete the transcript). For example, in some preferred embodiments all communications involving tax authorities may be deleted once the legally required storage period ends (in some countries, 3 years). As another example, in some preferred embodiments two parties 110 and 130 may agree to have deleted all correspondence between them once a certain transaction has been completed to the satisfaction of both.

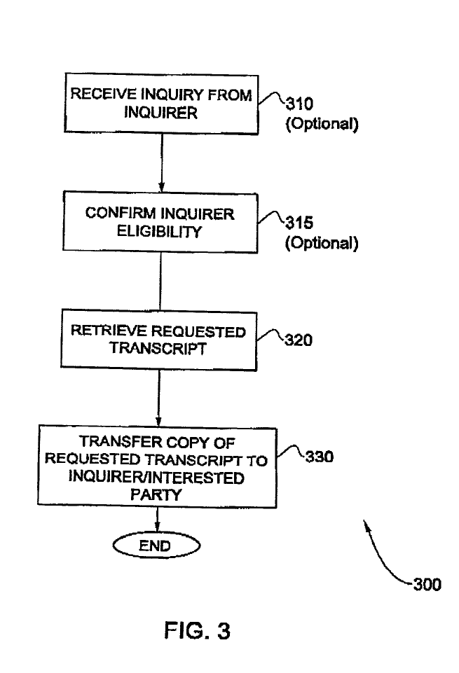

In preferred embodiments of the invention, during the storage period a stored transcript can not be modified by the parties 110 and 130 to the communication(s) included in the transcript. In some of these preferred embodiments, in order to increase the probability that a given stored transcript can not be modified by parties 110 and 130, at least part of the transcript contents are encrypted, the transcript contents are digitally signed and/or the transcript is not accessible online (i.e. the transcript is only available to parties 110 and 130 via customer service 165, for example by the method of FIG. 3 explained below)

The confirmation sent to source/originator party 110 in step 242 and/or destinations/auxiliary parties 130 in step 244, may be for example a copy of the transcript, a transaction number assigned by intermediary 180 and/or a confirmation sheet A confirmation sheet can include for example the source/originator party identification, destinations/auxiliary parties identification, and/or time of communication.

FIG. 3 shows a method 300 for providing authentication of communication(s), according to a preferred embodiment of the present invention, as followed by intermediary 180. Intermediary 180 optionally receives a request for a copy of a transcript from inquirer 140 in step 310, Inquirer 140 can identify the requested transcript by any identification which allows intermediary 180 to retrieve the correct transcript. For example, the identification can include one or more of the following: source/originator party identification, destinations/auxiliary parties identification, time or approximate time of communication(s), transaction number (if assigned), tracker (if assigned) etc.

Depending on the sensitivity of the information, in some preferred embodiments, inquirer 140 may need to conform to certain requirements, for example be located at a source/originator party 110 or destination/auxiliary parties 130 of the communication(s), prove to be the expected sender or one of the expected recipients of the communication(s), possess a legal right to view the communication, present a correct password, et. In these cases, intermediary 180 confirms the eligibility of inquirer 140 to receive information in optional step 315.

Alternatively, any inquirer 140 may receive any communication but only those with the decryption key can decipher the communication.

In some preferred embodiments, even without a prior request intermediary 180 may periodically send copies of communication transcripts, transcript summaries and/or identification information to interested party 140 (such as parties 110 and 130). For example, intermediary 180 may send identification information periodically or when allocated storage space has reached an assigned limit to parties 110 and 130 requesting that any transcripts which are no longer of interest be indicated for disposal (provided all parties 110 and 130 agree).

In step 320, intermediary 180 retrieves the communication transcripts, transcript summaries and/or identification information from storage 160. In step 330 the requested communication transcripts, transcript summaries and/or identification information is presented to inquirer/interested party 140.

During one inquiry, inquirer 140 may request one transcript (of a communication or series of communications) or many transcripts. For example, inquirer 140 may request the transcript of a conversation between a particular originator party 110 and auxiliary party 130 which occurred in the middle of January 2001. As another example, inquirer 140 may request all the transcripts of faxes between a certain source/originator party 110 and destinations/auxiliary parties 130.

Different preferred embodiments may use different classifications for storing transcripts in storage 160. It should be evident that the classification used affects the scope of inquiries. For example, if in a particular embodiment fax transcripts are time stamped and cross-referenced for date but not hour/minutes and also cross-referenced for source/originator party 110 and destinations/auxiliary parties 130, then an inquiry would cause retrieval of all faxes between a particular source/originator part 110 and destination/auxiliary party 130 transferred on a requested date and inquirer 140 would independently have to select the fax which was transferred at the requested hour/minutes.

In some cases a retrieved transcript may serve as evidence in a dispute involving parties of the communication (senders and/or recipients) and possibly other parties. For example, the transcript can attest to the sending of a certain content from an identified sender 110 or 130 to the official location of recipient 110 and/or 130 at a specific time. It is preferable, but not essential to the invention that such attestation is sufficient for a civil case. It is preferable but not essential to the invention, that a retrieved transcript which includes biometric identification of the sender 110 or 130 and/or recipients 110 and/or 130 (or perhaps some other indication that biometric identification was satisfactorily established) is sufficient to overcome reasonable doubt for a criminal case even if the retrieved transcript is the only evidence.

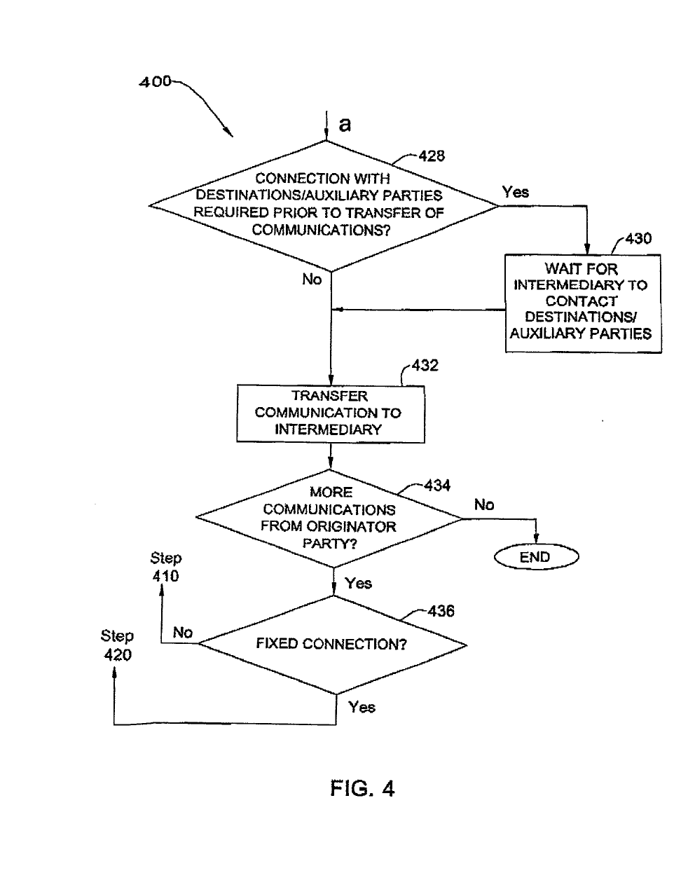

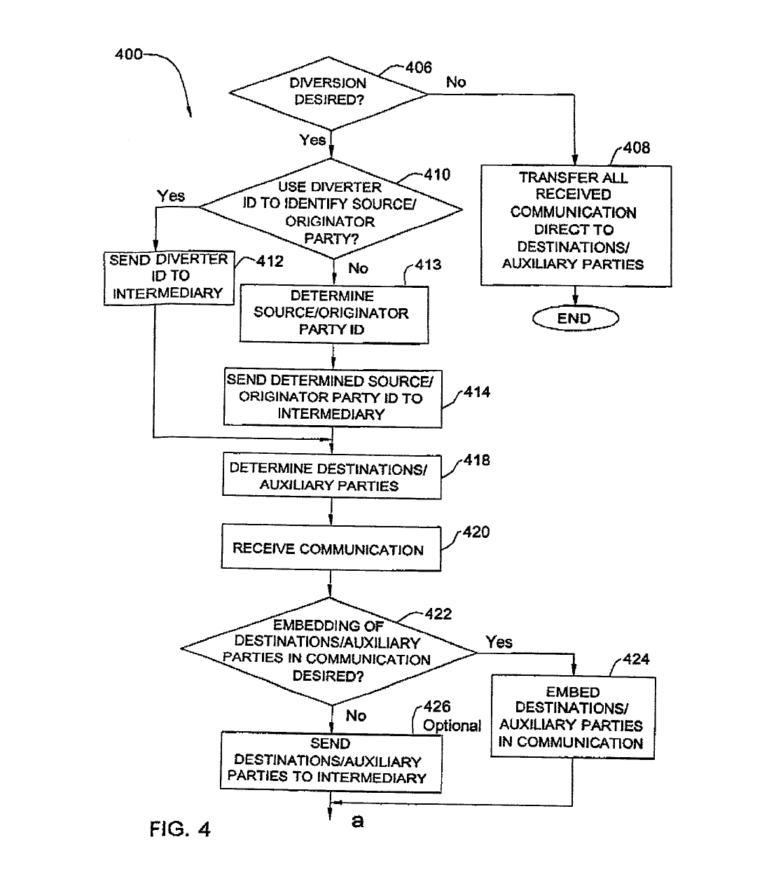

FIG. 4 shows a method 400 for diverting communication(s), according to a preferred embodiment of the present invention. It should be evident that the order of the steps are for ease of presentation and may be varied in other preferred embodiments.

In step 406, it is decided whether diversion is desired, for example depending on the existence and/or setting of switch 126/156. If diversion is not desired, all communications are between source/originator part 110 and destinations/auxiliary parties 130 without reception by intermediary 180. In some cases, such as if diverter 120 is in line with source/originator party 110, communications to and from destinations/auxiliary parties 130 may still pass through diverter 120 but with no diverting effect.

If diversion is desired, method 400 continues with steps performed by diverter 120 to divert communications from source/originator part 110 to intermediary 180. In some preferred embodiments, a source/originator party identification is determined in step 413 and sent to intermediary 180 in step 414. The determined source/originator party identification can be for example a location (see examples above), client identification, name, etc.

Diverter 120 can determine the source/originator party identification, for example, if the source/originator party identification is explicitly received by diverter 120 from source/originator party 110, if the source/originator party identification can be inferred by diverter 120 (for example using caller id), or if the source/originator party identification is familiar to diverter 120 (for example if diverter 120 connected to one source/originator party 110 or in the same unit 150 as source/originator party 110). It is also possible that a source/originator party identification other than the one received is determined (for example by a lookup table) and sent to intermediary 180. In some preferred embodiments the diverter identification is sent to intermediary 180 as a source/originator party identification (step 412) in the place of or in addition to the determined source/originator party identification.

In some preferred embodiments in steps 413 and 414, password/biometric identification of source/originator party 110 is instead or also determined and/or sent to intermediary 180. Examples include passwords, identification numbers, electronic signatures, digital signals, retina fingerprints, handprints, biometric signatures, voice signatures, other signatures, etc.

In step 418, diverter 120 determines a location (or another identification from which the location can be derived) of destinations/auxiliary parties 130 for a communication from source/originator party 110. Determination can be achieved for example by receiving the location or the derivative from source/originator party 110 (see examples of locations above).

In step 420, diverter 120 receives a communication from source/originator party 110. In some cases, step 420 may be delayed to right before step 432. For example if a connection with auxiliary parties 130 is required prior to transfer of communications to intermediary 180, diverter 120 may in some embodiments not allow reception of any communications from originator party 110 until after the connection with auxiliary parties 130 is established by intermediary 180.

If embedding of the location of destinations/auxiliary parties 130 is desired and has not already been performed by source/originator part 110, the location (or another form of identification from which the location can be derived) is embedded in the communication in step 424 and the communication transferred in step 432 includes the embedded location. If embedding is not desired, the location (or another form of identification from which the location can be derived) of destinations/auxiliary parties 130 is sent to intermediary 180 in step 426.

If intermediary 180 needs to first establish a connection with auxiliary parties 130 prior to receiving any communications, diverter 120 waits for intermediary 180 to contact auxiliary parties 130 in step 430 before transferring the communication to intermediary 180 in step 432. Otherwise the communication is transferred to intermediary 180 in step 432 independently of any connection establishing and/or forwarding by intermediary 180. If no more communications are to originate from originator party 110 then the process ends.

Otherwise, if the connection is fixed, the process iterates to step 420. Note that if the connection is fixed and no embedding is required, some or all communications from originator party 110 may go directly to diverter relay 133 for transfer to intermediary 180, without passing through replacer 121 and embedder 129 (i.e. for some or all subsequent communications, steps 422, 424, 426, 428, and 430 may be skipped with the process proceeding from iterated step 420 directly to step 432).

Alternatively, if there is no fixed connection then the process iterates to step 410. In some cases, instead of or in addition to diverter ID or determined source originator party ID, diverter 120 may send with subsequent communications the tracker established by intermediary 180 (which may have been transferred to divider 120 or source 110 by intermediary 180), or any other type of identification.

Below preferred embodiments are presented for different technologies. As mentioned above, a suitable preferred embodiment can be envisioned for any combination of physical communication medium with any application, and therefore the preferred embodiments presented below should be viewed as non-limiting.

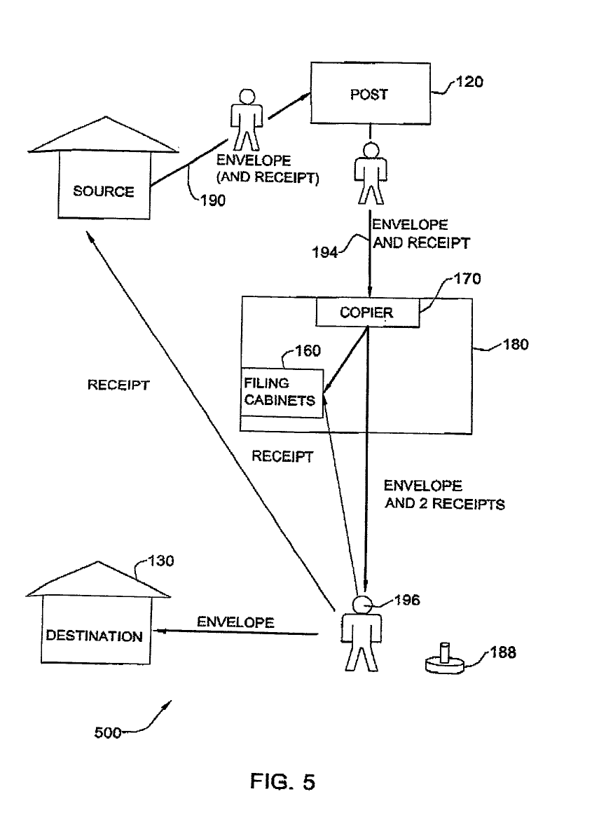

For mail (courier or postal service), “registered contents delivery” can be implemented in one preferred embodiment, as follows. See FIG. 5 for a block diagram of the described preferred embodiment for delivering mail via intermediary 180. Mail which requires registered contents delivery has this delivery method indicated for example on the envelope. The envelope with source and destination addresses (step 413 and 418), the contents of the envelope (step 420) and optionally an attached receipt that is addressed with the address of source 110 are received at the regular courier/post office or processing center (diverter 120). The regular courier/post office or processing center 120 diverts the received mail (steps 414, 426 and 432) to a secure processing center (intermediary 180). The diverted mail includes an envelope and contents to be delivered to destination 130 and the receipt with the source address which was either received by or attached at the regular courier/post office or processing center 120.

Secure processing center 180 receives the envelope, contents and attached receipt (steps 205, 217 and 220) At the secure processing center 180, the envelope is opened, a copy is made of the contents of the envelope (for example by photocopying, scanning, photographing, etc), and the contents are returned to the envelope. A transaction number is assigned to the copy. The transaction number is also stamped on the envelope, on the attached receipt with the address of the source, and on a second receipt with the address of the secure processing center which is attached at secure processing center 180. Optionally the address of source 110 and destination 130 are noted on or with the copy. The envelope with contents thereof is delivered to destination 130 as and must be signed for on the second receipt (step 230). The delivery person 196 uses time stamp 188 to stamp the time of delivery (at least date, month and year and preferably also hour and minutes) on the receipt which is returned to source 110 (step 242) and on the second receipt which is returned to secure processing center 180.

When secure processing center 180 receives the second receipt with the time stamp, secure processing center 180 stores the second receipt along with the copy of the contents (step 240). The storage can be of electronic copies (i.e. digital copies of contents and receipt are stored) in a database 160 or of hardcopies (including paper, microfiche, slides, etc.) In a physical storage 160 such as filing cabinets. Preferably the copy and receipt are filed under the transaction number. As source 110 and destination 130 are informed of the transaction number, either source 110 or destination 130 can afterwards request presentation of the stored time stamped copy (method 300).

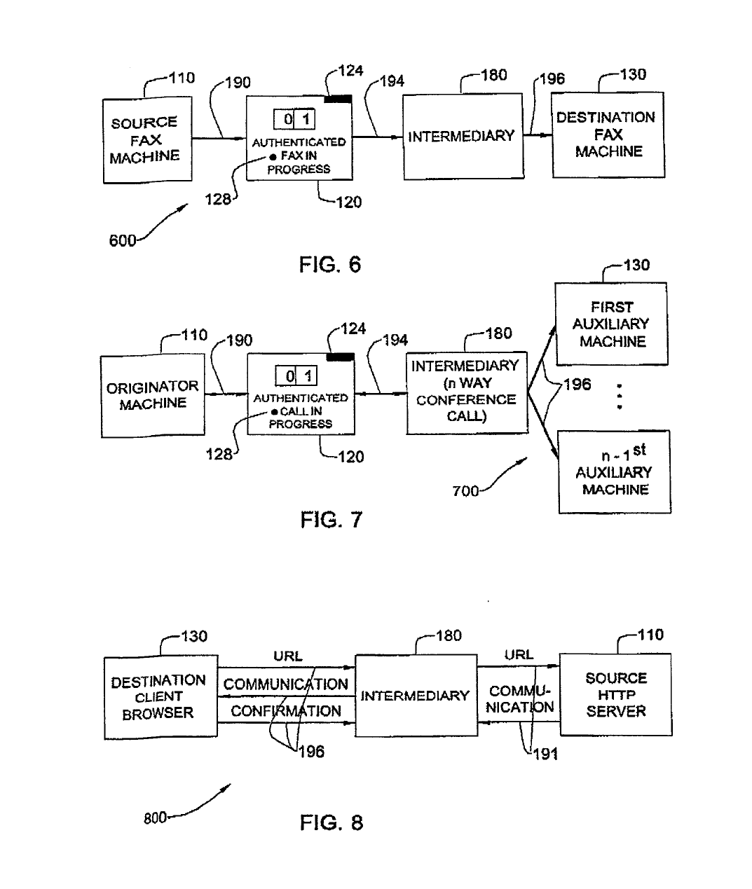

For facsimile communications, the invention can be implemented in one preferred embodiment as follows. Refer to FIG. 6 which shows a system 600 which can be used for delivering faxes via intermediary 180. Source fax machine 110 dials the fax number (location) of target fax machines 130. Instead of reaching the main telephone network, the number is rerouted into diverter 120 and stored as the destination number (step 418). Diverter 120 dials the number of intermediary 180. In this preferred embodiment intermediary 180 is for example a fax server. When server 180 picks up the line, diverter 120 sends the unique identification of the diverter (step 412) and the fax number of target fax machines 130 (step 426). This sending can be performed for example through pluses, tones, modem and can be overt or encrypted. Steps 412 and/or 426 may include a feedback to confirm that the information has been communicated correctly. Preferably other identification and encryption methods such as caller ID and RSA public/private keys are also used. The communication is then faxed to intermediary 180 (step 432). On the intermediary 180 end, the unique identification of diverter 120 (which functions as source identification), the target fax numbers (location of destinations 130) and the communication are received (steps 205, 217 and 220). Intermediary 180 then faxes the communication to destinations 130 (step 230). Intermediary 180 stores, for example electronically in database 160, the transcript which includes the fax content and time stamp, and preferably the target fax numbers and diverter identification (step 240). Optionally a confirmation fax is sent to source fax machine 110 (step 242).

Note that the process described above for faxing is transparent to the sender because the sender dials the target fax numbers as usual. If there is more than one target fax number, the numbers can be dialed in some preferred embodiments separated by the pound sign. In some preferred embodiments, diverter 120 can be a separate unit connected to fax machine 110, for example diverter 120 my be connected to fax machine 110 and also to a telephone socket for connection to PSTN (public switched telephone network) 194. In some preferred embodiments diverter 120 can be powered from the mains or may be powered from battery (for example for use with portable devices). In some preferred embodiments there is a switch 126 in diverter 120 which when turned off short circuits the input and output of diverter 120 so that diverter 120 has no diverting effect (i.e. faxes are transmitted to destinations 130 without being diverted to intermediary 180). In some preferred embodiments there is a feedback indicator 128 in diverter 120 which can be for example an LED (light emitting diode)

In some preferred embodiments, diverter 120 can be included in the same unit as fax machine 110 (not shown), in a configuration in accordance wit FIG. 1c.

Note that fax communication using media instead of or in addition to telephone wires can be implemented in a similar configuration to system 600, mutatis mutandis. Examples include wireless, satellite or optical fax.

Also note that the configuration of FIG. 6 can be used in other preferred embodiments for one-way telephone communications such as one-way verbal (for example for leaving a voice mail) or one way data or video transfer, with source fax machine 110 and destination fax machine 130 replaced in those preferred embodiments by appropriate PSTN source and destination machines 110 and 130 (for example telephones, answering machines, data transmitter/receiver, video signal transmitter/receiver, etc.).

FIG. 7 shows an implementation 700 of the invention for an interactive communication using the PSTN, according to a preferred embodiment of the present invention. System 700 can be used for verbal phone communication and non-verbal phone communication, including fax transmission, data transmission and video signal transmissions.

The connection initiator machine (originator party 110) dials the number (location) of the one or more auxiliary party machines 130. If there is more than one auxiliary party machine 130, separating for example any additional numbers of auxiliary parties machines 130 with the pound sign. The number is a PSTN number and can therefore be a telephone, fax, et, number. Instead of reaching the main telephone network, the number is rerouted into diverter 120 and stored as the original target number(s) (step 418). Diverter 120 dials the number of intermediary 180. Intermediary 180 is for example in this preferred embodiment a server. When intermediary 180 picks up the line, diverter 120 transmits the unique identification of diverter 120 (step 412) and the target number(s) (step 426). Preferably other identification and encryption methods are also used such as caller ID and RSA public/private keys. Intermediary 180 receives the unique identification of diverter 120 and the target phone number(s) (steps 205 and 217) and using the target phone numbers establishes a connection with auxiliary parties machines 130 (step 219), preferably without disconnecting the line with originator part 110 through diverter 120. The connection can either be established through a multi party conference call or by emulating a conference call, for example by calling each party machine individually and establishing a real time audio connection between lines. If required by law, due notices of recording are issued.

Diverter 120 waits for the contact between intermediary 180 and auxiliary parties machines 130 to be established (step 430) before receiving (step 420) and transferring the first communication from originator party 110 to intermediary 180 (step 432). It should be evident that the first communication from originator party 110 may not be identical to the first communication transferred by intermediary 180 between parties machines 110 and 130 (i.e. one or more of auxiliary parties machines 130 may be the first to transmit a communication). As the connection is fixed, intermediary 180 receives and transfers communications between parties machines 110 and 130 (iteration 220 and 230). The communications pass through diverter 120. Intermediary 180 makes an electronic recording of the communication and stores the communication recording and time stamp along with preferably the target phone number(s) and diverter identification (i.e. store the transcript) for example electronically in database 160 (step 240). Optionally, a confirmation recording is played back to originator party 110 (step 242)

In some cases, the public telephone exchange forms part of intermediary 180. Note a the public telephone exchange is generally busted by users of the telephone system. The public telephone exchange establishes the connection and/or transfer the communications between parties machines 110 and 130. In some of these cases, another part of intermediary 180 in another location records the communications.

Note that the process described above is transparent to the sender because the sender dials the target number as usual, waits for a response and starts communicating. Initiator machine 110 and/or auxiliary party machines 130 can be any machine which can transmit and/or receive over the telephone system, for example depending on the preferred embodiment a telephone, fax, data transmitter/receiver, video signal transmitter/receiver, etc. In some preferred embodiments, diverter 120 can be a separate unit connected to both initiator machine 110 and to a telephone socket for connection to PSTN 194. In some preferred embodiments diverter 120 can be powered from the mains or may be powered from battery (for example for use with portable devices). In some preferred embodiments there is a switch 126 in diverter 120 which when turned off short circuits input and output of diverter 120 so that diverter 120 has no diverting effect (i.e. communication is established with auxiliary parties 130 without first being diverted to intermediary 180). In some preferred embodiments there is a feedback indicator 128 in diverter 120 which can be for example an LED.

In some other preferred embodiments, diverter 120 can be included in the same unit as initiator machine 110 (not shown) in accordance with FIG. 1c.

FIG. 8 shows an implementation 800 for web pages, according to a preferred embodiment of the present invention. In this implementation, intermediary 180 acts as a proxy server.

A client browser (destination 130) as part of a request contacts intermediary 180 and provides the URL of a known web page (the web page being a communication) to be time stamped and stored (step 202). The URL also identifies the HTTP server i.e. the source 110 of the web page. For example, the web page may display a purchase receipt and summary of a transaction. The request can be sent for example via network 196. Intermediary 180 independently contacts HTTP server 110 and solicits the page identified by the URL (step 218). Server 110 sends the requested page which is received by intermediary 180 (step 220). Intermediary 180 forwards the web page to client browser 130 for confirmation that the forwarded page is identical to the desired page (step 230). Once confirmation of the page is received (step 237), the transcript is archived, for example electronically in database 160 in step 240. The transcript includes the page and the time stamp (for example of the retrieval time) and preferably the URL of the retrieved page (which also serves to identify HTTP server 110) and/or the client ID of browser 130.

In some preferred embodiments, there is a button or command on web browser 130 which allows the URL of a viewed page to be sent to intermediary 180 for receipt as in step 202. Alternatively, in some preferred embodiments there might be a button displayed on the web page itself suggesting that if pressed a retransmission of the web page through 180 will be initiated (for example, “click here to authenticate this web page”).

In some preferred embodiments, the comparison of the forwarded page and the known page can be performed by the user or automatically by the software on the client side, for example as part of browser 130.

A similar configuration to FIG. 8 can be used to store any digital output generated by an Internet server 110, including HTML pages, images, downloadable files, voice and video streams.

In other preferred embodiments a system (not shown) similar to FIG. 1c can be used for web pages, with the sent URL considered the first of two communications, the client browser functioning as an originator part 110 and the HTTP server as an auxiliary party 130. In the same unit 150 as the web browser 110 would be a diverter 120 and the web browser button or command mentioned above would set the diversion mode 156 on and cause the URL to be diverted via intermediary 180.

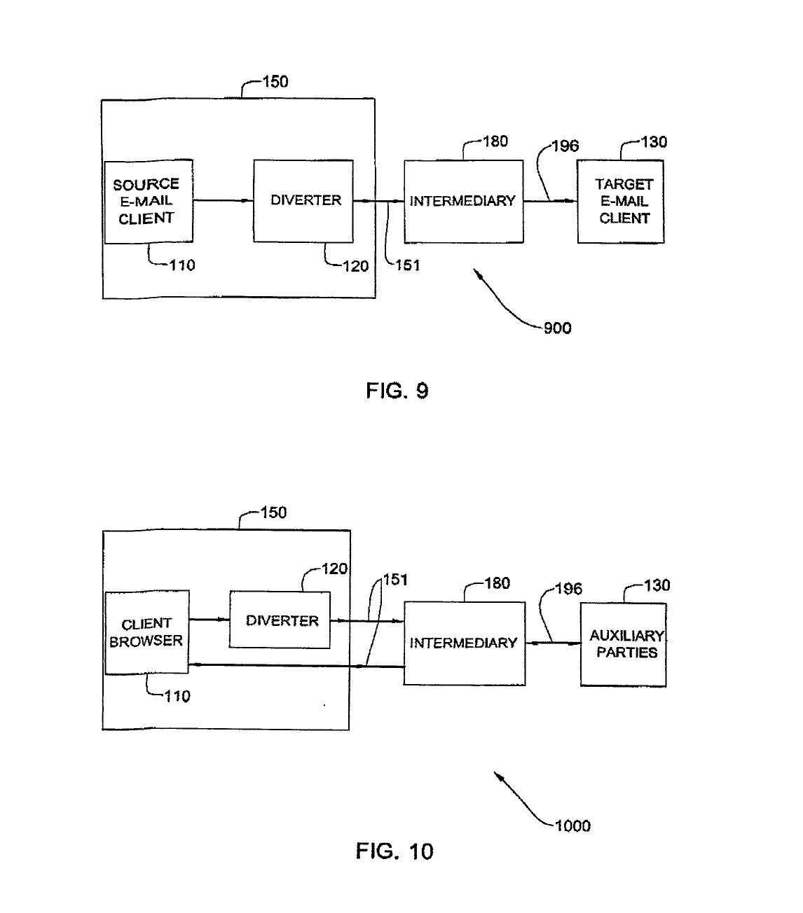

FIG. 9 shows an implementation 900 for transferring electronic mail via the Internet according to a preferred embodiment of the present invention.

The source email client 110 prepares the email to be transmitted and enters the email address (location) of target email clients 130. It is assumed that within the same unit 150 that includes source email client 110 there is diverter 120. For example diverter 120 may be software code that is part of an email software program or software code that exchanges data with an email software is program. Unit 150 can alternatively represent a machine, for example a computer, which runs software 110 and 120. The email is received by diverter 120 (steps 413, 418 and 420). Diverter 120 replaces the email address of target email clients 130 with the address of intermediary 180. Intermediary 180 is for example in this preferred embodiment an SMTP (email) server. Preferably diverter 120 embeds the email address of targets 130 in the email or otherwise in the modified target, for example by adding a suffix representing intermediary 180 to the email address of targets 130 (step 424). As an example for illustration purposes,, if the intended recipient is alice@a.com diverter 120 adds a suffix for intermediary 180 (enotary.cc) so that the modified target becomes alice@.com.enotary.cc with the original address embedded in it. The communication (email) (which is assumed to include the embedded email address of destinations 130) is sent to intermediary 180 along with preferably the email address of source email client 110 (steps 414 and 432).

Intermediary 180 receives the communication and the source identification (email address) in steps 205 and 220. Intermediary 180 parses the email and recovers the embedded destinations email address (step 222) and then transfers the communication to targets 130 (step 230). Intermediary stores a transcript including the email content and time stamp along with preferably the email addresses of targets 130 and/or source 110 in database 160 (step 240). Optionally a confirmation email is emailed to source 110 (step 242).

Optionally additional known methods are employed to verify the recipient, for example a) testing target POP server, confusing that IP address matches email address from previous experience; and/or asking recipient to log in and actively download the email.

In some preferred embodiments, the activation of a divert button or is command 156 that is part of unit 150 causes the rerouting of the email to intermediary 180. The divert button/command 156 can be activated, for example instead of the regular send command/button, when diversion is desired. The process is transparent to the email sender because the sender just creates the email, fills in the target address and presses a different button (i.e. button 156). Alternatively, unit 150 can be configured for zero overload so that all emails are notarized and no special button needs to exist, just the regular send button.

The embedding can in other preferred embodiments be performed manually at source 110, eliminating the need for diverter 120.

FIG. 10 shows an implementation 1000 for interactive web sequences, according to a preferred embodiment of the present invention. Implementation 1000 can in some cases be used to create a transcript not only of a final web document but also the sequence of events that led to the final web document, for example for establishing intent when dealing with web contracts.

In order to allow the recording of an interactive web sequence, intermediary 180, is specified as a proxy server for client browser (originator party) 110.

It is assumed that within the same unit 150 that includes originator party client browser 110, for example within the same or interconnected software program, there is diverter 120. For example diverter 120 may be software code that is party of a browser software program or exchanges data with a browser software program. Unit 150 can also represent a machine, for example a computer, which runs software programs 110 and 120. Diverter 120 diverts any outgoing communication to intermediary 180 when diversion mode 156 is set For example in some preferred embodiments when a button that is part of unit 150 is pressed the communications are diverted and when the button is released, diversion ends. When diversion is initiated, diverter 120 sets “proxy” settings in the browser program to the settings of intermediary (i.e. diversion desired step 406). Diverter 120 sends ID information of originator party browser 110 to intermediary 180 (step 414). On the other end, intermediary 180 receives ID information of originator party browser 110 (step 205) and establishes a tracker (session ID) (step 214). From this time forward until diversion mode 526 is turned off, communications from browser 110 and location of auxiliary parties 130 that are received from originator party browser 110 by diverter 120 (steps 418 and 420) are sent to intermediary 180 (steps 426 and 432). If necessary, identification of originator party 110 is also sent to intermediary 180 along with each communication originating from originator party 110 (steps 414.) For each communication that intermediary 180 receives from diverter 120 (steps 220 or 234) and establishes the sender as being originator party 110 (steps 205 or 235), intermediary 180 receives the location of auxiliary parties 130 (for example URL) in step 217 or 236, and transfers the communication to auxiliary parties 130 (step 230). For each communication originating from auxiliary parties 130 (i.e. In response to a communication from originator party 110) that is received in step 234, intermediary 130 establishes the communication as originating from auxiliary party 130 in step 235 and forwards the communication to originator party 110 in step 230.

Usually for each communication received from sender 110 (possibly via diverter 120) or 130, intermediary 180 also receives an identifier for sender 110 or 130 and recipient 110 or 130. For example if the communication is HTTP over TCP/IP, the IP addresses may be received as identifiers.

In cases where the interaction is secure (e.g. SSL), it is assumed that switching IP addresses during the middle of the secure session is not allowed and therefore the series of communications (session) should start before the secure session begins. Once the series of communications is terminated, intermediary 180 stores a transcript of the interactive web communications including some or all of interactive selections and manipulations, form submissions, posting and/or transmitted pages as well as time stamps in step 240.

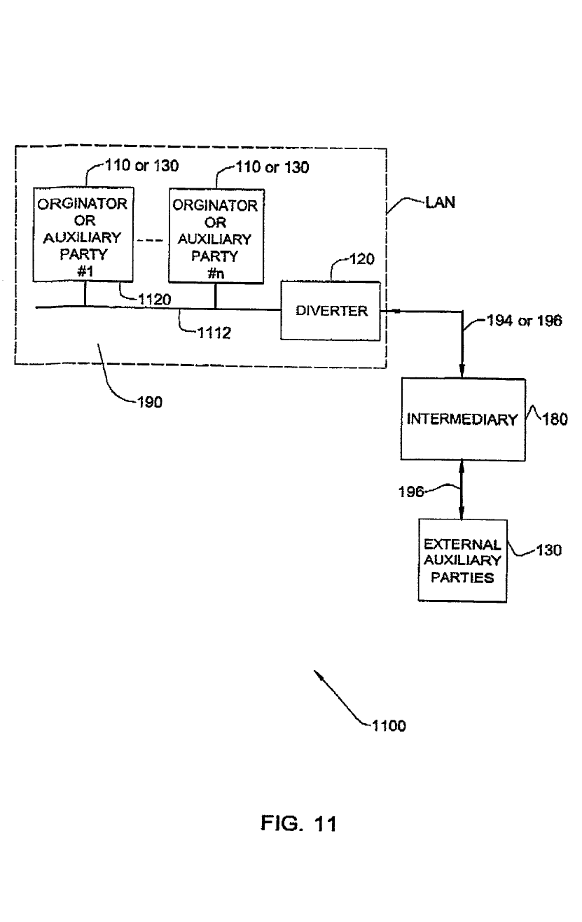

FIG. 11 illustrates an implementation 1100 which can be used for general data communications via Ethernet and TCP/IP, including email, interactive or non-interactive web sequences, telephone over IP, fax over email, fax over IP, video conferencing, and pure data transmission, in accordance with a preferred embodiment of the present invention.

A local area network (LAN) 190 has one or more devices 1120 connected to Ethernet cable 1112. For any given communication, a particular device 1120 can be a source/originator party 110 (i.e. a source of a one-way communication or an initiator of communications in more than one direction) and/or a destination/auxiliary party 130 (i.e. a destination of a one-way communication or a non-initiator of communications in more than one direction). Devices 1120 in LAN 190 can be arranged in any suitable topology. In addition to LAN 190, network 1100 which is preferably packet based includes intermediary 180 and external destinations/auxiliary parties 130. In line (i.e. series) with Ethernet cable 1112 is diverter 120 so that any communication within LAN 190 or between devices 1120 and external destinations/auxiliary parties 130 pass through diverter 120. Alternatively (not shown) diverter 120 may be embedded in network card hardware, or in a network software driver.

A given communication or series of communications and the related information originate from one of devices 1120 (i.e. source/originator part 110). The communication(s) and related information are passed by Ethernet cable 1112 to diverter 120. Diverter 120 receives one or more streams of packets of data. Each stream received includes information (for example location) relating to source/originator party 110, information (for example location) relating to destination/auxiliary parties 130 (internal and/or external), and (at least part of) a communication (steps 413, 418, and 420). If local area network 190 connects only one device 1120 or if diverter 120 can determine the originating device 110, then stream received by diverter 120 from source/originator party 110 need not include source/originator party information and diverter 120 may add the source/originator party information prior to forwarding the stream to intermediary 180.

Diverter 120 redirects the streams to intermediary 180 (replacing the location of destinations/auxiliary parties 130 with the location of intermediary 180) and for each stream inserts an additional packet which contains information (location) about the original destination/auxiliary parties 130 (steps 414, 426,and 432). This additional packet is used by intermediary 180 in relaying the stream to destinations/auxiliary parties 130. Intermediary 180 receives each stream (step 205, 217, and 220, or 234, 235 and 236). If necessary, for example for a series of communications involving more than one direction, or desired for a particular implementation, intermediary 180 assigns a tracker (step 214) for all streams received from diverter 120 so that a reverse communication can be forwarded to the same source/originator part 110. Each stream of communication (preferably without the additional packet) is forwarded to auxiliary parties 130 (step 230). If a stream received by intermediary 180 originates from auxiliary parties 130, as in the case of multi-directional communication (step 234), the stream is transferred to originator party 110 (step 230), with intermediary 180 possibly relying on the tracker to recall originator party 110. Once communications are terminated intermediary stores a transcript of the communication(s) in step 240. Communications may be considered terminated for example once diverter 120 is switched off and therefore sends a “close” signal. As another example, communications can be considered terminated when there is no communication for some period of time (“timeout”).

Diverter 120, can be for example a hardware device. As another example, diverter 120 can be implemented in software, for example as a network card driver. As yet another example, diverter 120 can be implemented as a firewall that traps and relays packets or frames on the TCP/IP stack, or at a lower level, or for other protocols. Diverter 120 can as another example be incorporated into existing network cards, router, firewalls and operating systems belonging to network 194 in a way that is transparent to a user.

In some preferred embodiments, for example for standard protocols such as HTTP, FTP, Telnet, STMP, etc, selective recording by intermediary 180 is possible. For example, a user may choose to have intermediary 180 record only emails outgoing to specific email addresses and web pages downloaded from selective web sites.

In some preferred embodiments of system 1100, intermediary 180 is able to reproduce the stream of packets in tile right order but the interpretation is application/protocol specific, and possibly encrypted, depending on the application that produced the sequence and the protocol according to which it was produced

The issue of trust will now be briefly discussed. In preferred embodiments of the present invention, the usage of any intermediary 180 or a particular intermediary 180 for communications causes parties 110/130 to trust more the communications. The usage of intermediary 180 preferably allows parties 110/130 to consider the communications as non-forgeries, to view as intact the integrity of the contents of the communications, and to consider the communications as nonrepudiable, provided intermediary 180 is a trusted intermediary from the viewpoint of the parties 110/130. It is preferable but not essential to the invention that in order to increase trust in intermediary 180, intermediary 180 complies inter alia with one or more of the following criteria: is licensed or certified by a private or government agency, is independent of parties 110/130, uses a trust-worthy system, provides a secure storage for transcripts, discloses practices and procedures, provides warranties, follows certain rules governing personnel files a bond or suitable guarantee, possesses sufficient working capital, and/or maintains offices in a specific location

It is likely, but not essential for the invention, that increased trust in communications involving intermediary 180 will lead to increased usage of certain forms of communications such as electro-magnetically propagated communications.

It will also be understood that the system according to the invention may be a suitably programmed computer. Likewise, the invention contemplates a computer program being readable by a computer for executing the method of the invention. The invention Her contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

1. A method for authenticating electro-magnetically propagated communications, comprising the steps of:
an intermediary receiving at least one electro-magnetically communication from at least one sender which is intended for at least one recipient;
said intermediary transferring said at least one communication to said at least one recipient; and
said intermediary storing a transcript including at least part of a content of said at least one communication and a time associated with said at least one communication;
wherein a period of said storing complies with at least one from a group including: permanent storing, storing for as long as required by law, and storing until cessation of storing as agreed upon by all said at least one sender and all said at least one recipient; and
wherein during said period of said storing, said transcript can not be modified by any of said at least one sender nor by any of said at least one recipient.

2. The method of claim 1, wherein said transcript is configured to serve as evidence in the case of a dispute involving at least one party from a group including: said at least one sender and said at least one recipient.

3. The method of claim 1, wherein said at least part of a content includes all of a content of said at least one communication.

4. The method of claim 1, further comprising prior to the step of receiving at least one communication the steps of:
said intermediary receiving information from said at least one recipient about said at least one communication, said information identifying both said at least one sender and said at least one communication; and
said intermediary contacting said at least one sender and requesting said at least one communication.

5. The method of claim 4, wherein said information is a URL.

6. The method of claim 4, further comprising the step of:
said intermediary receiving confirmation that said at least one communication is as desired from said at least one recipient after the step of transferring and prior to the step of storing.

7. The method of claim 1, further comprising the step of:
said intermediary receiving information identifying said at least one recipient.

8. The method of claim 7, wherein said information identifying said at least one recipient is at least one from a group including: email address, mail address, post office box, fax number, telephone number, Internet Protocol (IP), URL (uniform resource locator), Smalltalk address, Ethernet address, caller identification (ID), name, client identification, diverter identification, password, identification number, electronic signature, digital signatures, retina fingerprint handprint, biometric signature, voice signature, and other signature.

9. The method of claim 7, wherein said information identifying said at least one recipient is a protocol specific identifier.

10. The method of claim 7, wherein said information identifying said at least one recipient is embedded in said at least one communications and wherein said step of receiving information includes the step of:
recovering said information identifying said at least one recipient from said at least one communication.

11. The method of claim 1, further comprising the step of:
said intermediary establishing a connection between said at least one sender and said at least one recipient and said intermediary prior to the step of receiving.

12. The method of claim 1, wherein said transcript also includes information identifying said at least one sender.

13. The method of claim 12, wherein said information identifying said at least one sender is at least one from a group including: email address, mail address, post office box, fax number, telephone number, Internet Protocol (IP), URL (uniform resource locator), Smalltalk address, Ethernet address, caller identification (ID), name, client identification, diverter identification, password, identification number, electronic signature, digital signatures, retina fingerprint, handprint, biometric signature, voice signature, and other signature.

14. The method of claim 12 wherein said information identifying said at least one sender is a protocol specific identifier.

15. The method of claim 1, wherein said transcript also includes information identifying said at least one recipient.

16. The method of claim 15, wherein said information identifying said at least one recipient is at least one from a group including: email address, mail address, post office box, fax number, telephone number, Internet Protocol (IP), URL (uniform resource locator), Smalltalk address, Ethernet address, caller identification (ID), name, client identification, diverter identification, password, identification number, electronic signature, digital signatures, retina fingerprint, handprint, biometric signature, voice signature, and other signature.

17. The method of claim 15, wherein said information identifying said at least one recipient is a protocol specific identifier.

18. The method of claim 1, further comprising the steps of:
said intermediary sending a confirmation of said transferring step to at least one from a group including said at least one sender and said at least one recipient.

19. The method of claim 1, wherein said at least one communication is encrypted.

20. The method of claim 1, wherein said at least one communication includes at least one communication whose sender in at least one other communication of said at least one communication is a recipient.

21. The method of claim 20, wherein at least two of said at least one communication together establish intent which can not be deduced from examining each of said at least one communication separately.

22. The method of claim 1, wherein said at least one communication includes the same sender for all of said at least one communication.

23. A method for authenticating communications, comprising the steps of:
an intermediary receiving at least one communication from at least one sender which is intended for at least one recipient;
said intermediary transferring said at least one communication to said at least one recipient; and
said intermediary storing a transcript including at last part of a content of said at least one communication and a time associated with said at least one communication;
wherein a period of said storing complies with at least one from a group including: permanent storing, storing for as long as required by law, and storing until cessation of storing as agreed upon by all said at least one sender and all said at least one recipient; and
wherein during said period of said storing, said transcript can not be modified by any of said at least one sender nor by any of said at least one recipient.

24. The method of claim 23, wherein said at least one communication is mail.

25. A method for authenticating electro-magnetically propagated communications, comprising the steps of:
a trusted intermediary receiving at least one electro-magnetically communication from at least one sender which is intended for at least one recipient;
said intermediary transferring said at least one communication to said at least one recipient; and
said intermediary storing a transcript including at least part of a content of said at least one communication and a time associated with said at least one communication; said transcript being configured to serve as evidence in the case of a dispute involving at least one party from a group including: said at least one sender and said at least one recipient;
wherein a period of said storing complies with at least one from a group including: permanent storing, storing for as long as required by law, and storing until cessation of storing as agreed upon by all said at least one sender and all said at least one recipient; and
wherein during said period of said storing, said transcript can not be modified by any of said at least one sender nor by any of said at least one recipient.

26. A method for providing authentication of electro-magnetically propagated communications, comprising the steps of:
receiving an inquiry from an inquirer about at least one electro-magnetically propagated communication which involving a trusted intermediary;
retrieving a transcript stored by said intermediary, said transcript including at least part of a content of said at least one communication and a time associated with said at least one communication; and
transferring said script to said inquirer; wherein said transferred transcript is used as evidence in a dispute involving at least one party from a group including: at least one sender and at least one recipient of at least one of said at least one communication;
wherein said stored transcript was stored for a period complying with at least one from the group including: permanent storing, storing for as long as required by law, and storing until cessation of storing as agreed upon by all said at least one sender and all said at least one recipient, and wherein during said period of storing, said transcript could not be modified by any of said at least one sender nor by any of said at least one recipient.

27. A method for diverting electro-magnetically propagated communications for authentication, comprising the steps of:
a diverter receiving at least one electro-magnetically propagated communication from at least one sender which is intended for at least one recipient; and
said diverter transferring said at least one communication to an intermediary;
wherein said intermediary authenticates said at least one communication by an authenticating process including storing a transcript including at least part of a content of said at least one communication and a time associated with said at least one communication for a storing period complying with at least one from a group including: permanent storing, storing for as long as required by law, and storing until cessation of storing as agreed upon by all said at least one sender and all said at least one recipient, and wherein during said storing period said transcript can not be modified by any of said at least one sender nor by any of said at least one recipient.

28. The method of claim 27, wherein said step of transferring includes the step of: transferring information related to said at least one recipient for use by said intermediary as part of said authenticating process in forwarding said at least one communication to said at least one recipient.

29. The method of claim 28, wherein said step of transferring information includes the step of:
embedding said information related to said at least one recipient in said at least one communication, said information when recovered allowing said intermediary as part of said authenticating process to forward said at least one communication to said at least one recipient.

30. The method of claim 27, further comprising the step of:
said diverter transmitting a diverter identification to said intermediary.

31. An apparatus for diverting electro-magnetically propagated communications for authentication, comprising:
a replacer configured to replace locations of recipients or derivatives thereof with a location of an intermediary;
and a diverter relay configured to transfer electro-magnetically propagated communications for said recipients to said intermediary, in accordance with said replaced location;
wherein said intermediary authenticates said communications by an authenticating process including storing transcripts including at least part of contents of said communications and times associated with said communications for storing periods complying with at least one from a group including: permanent storing, storing for as long as required by law, and storing until cessation of storing as agreed upon by all senders and all recipients of corresponding communications, and wherein during said storing periods said transcripts can not be modified by any of said senders nor by any of said recipients.

32. The apparatus of claim 31, further comprising:
a memory configured to store said location of said intermediary; wherein said replacer accesses said memory to retrieve said location of said intermediary.

33. The apparatus of claim 31, further comprising:
an embedder configured to embed said locations of said recipients or derivatives thereof in said communications, said locations or said derivatives when recovered allowing said intermediary as part of said authenticating process to transfer said communications to said recipients.

34. The apparatus of claim 31 wherein said diverter relay is also configured to transfer said locations of said recipients or derivatives thereof to said intermediary, there by enabling said intermediary as part of said authenticting process to transfer said communications to said recipients.

35. The apparatus of claim 31, further comprising:
a memory configured to store an identification of the apparatus, wherein said diverter relay is also configured to transfer said identification to said intermediary.

36. The apparatus of claim 31, wherein said apparatus is included in a same unit as a source/originator party.

37. The apparatus of claim 36, wherein said unit further comprises a switch configured to provide at least one mode of operation, with a first provided mode causing diversion to said intermediary, and a second provided mode allowing said communications to pass through to said recipients.

38. The apparatus of claim 36, wherein said unit further comprises an indicator configured to indicate that diversion to said intermediary is in progress.

39. The apparatus of claim 36, wherein said unit further comprises an interface port configured for reprogramming an identification for said apparatus.

40. The apparatus of claim 39, wherein said interface port is also configured for testing said apparatus.

41. The apparatus of claim 39, wherein said interface port is also configured for reprogramming said location of said intermediary.

42. The apparatus of claim 31, wherein said apparatus further comprises a switch configured to provide at least one mode of operation, with a first provided mode causing diversion to said intermediary, and a second provided mode allowing said communications to pass through to said recipients.

43. The apparatus of claim 31 wherein said apparatus further comprises an indicator configured to indicate that diversion to said intermediary is in progress.

44. The apparatus of claim 31 wherein said apparatus further comprises an interface port configured for reprogramming an identification for said apparatus.

45. The apparatus of claim 44, wherein said interface port is also configured for testing said apparatus.

46. The apparatus of claim 44, wherein said interface port is also configured for reprogramming said location of said intermediary.

47. The apparatus of claim 31, wherein said apparatus is portable.

48. The apparatus of claim 31, wherein said apparatus is included in a component of a communication network.

49. The apparatus of claim 48, wherein said component is at least one from a group including: network card hardware, network software card drivers, routers, firewalls, and operating systems.

50. A system for authenticating electro-magnetically propagated communications, comprising:
a relay configured to transfer electro-magnetically propagated communications from sender to recipients;
a timestamp module configured to associate times with said communications; and
a storage configured to store transcripts including at least part of contents of said communications and said times associated with said communications,
wherein said storage is configured to store each said transcripts for a storing period that complies with at least one from a group including: permanent storing, storing for as long as required by law, and storing until cessation of storing as agreed upon by all senders and all recipients of communications corresponding to said each said transcripts; and wherein said storage is configured to prevent said transcripts from being modified by said senders and said recipients during said storing period.

51. The system of claim 50, further comprising:
a parser configured to parse received communications in order to recover embedded information about recipients of said communications.

52. The system of claim 50, further comprising:
a request processor configured to process requests from said recipients to obtain communications from said senders.

53. The system of claim 50, wherein said storage is configured to also store as part of said transcripts information identifying at least one from a group including said sender and said recipients.

54. The system of claim 50, further comprising a biometric device for verifying biometric identification of at least one from a group including said senders and said recipients.

55. A system for authenticating communications, comprising:
a relay configured to transfer communications from senders to recipients;
a timestamp module configured to associate times with said communications; and
a storage configured to store transcripts including at least part of contents of said communications and said times associated with said communications,
wherein said storage is configured to store each said transcript for a storing period that complies with at least one from a group including: permanent storing, storing for as long as required by law, and storing until cessation of storing as agreed upon by all senders and all recipients of communications corresponding to said each said transcripts, and wherein said storage is configured to prevent said transcripts from being modified by said senders and said recipients during said storing period.

56. A system for authenticating electro-magnetically propagated communications, comprising:
a relay configured to transfer electro-magnetically propagated communications from senders to recipients;
a timestamp module configured to associate times with said communications; and
a storage configured to store transcripts including at least part of contents of said communications and said times associated with said communications, wherein said storage is configured to store each said transcripts for a storing period that complies with at least one from a group including: permanent storing, storing for as long as required by law, and storing until cessation of storing as agreed upon by all senders and all recipients of communications corresponding to said each said transcripts; and wherein said storage is configured to prevent said transcripts from being modified by said senders and said recipients during said storing period; said each said transcripts being configured to serve as evidence in the case of a dispute involving at least one party from a group including: said senders and said recipients of communications corresponding to said each said transcripts.

57. A system for providing authentication of electro-magnetically propagated communications, comprising:
a storage configured to store transcripts prepared by a trusted intermediary for electro-magnetically propagated communications between senders and recipients, said transcripts including at least part of contents of said communications and times associated with said communications; and
a customer service configured to receive requests from inquirers for particular communications, to retrieve corresponding transcripts from said storage and to transfer said transcripts to said inquirers, wherein said transferred transcripts are used as evidence in disputes involving at least one party from a group including: said senders and said recipients;
wherein said storage is configured to store each said transcripts for a storing period that complies with at least one from a group including: permanent storing, storing for as long as required by law, and storing until cessation of storing as agreed upon by all senders and all recipients of communications corresponding to said each said transcripts and wherein said storage is configured to prevent said transcripts from being modified by said senders and said recipients during said storing period.

58. A system for authenticating electro-magnetically propagated communications, comprising:
at least one source/originator party;
at least one destination/auxiliary party; and
an intermediary;
wherein said intermediary is configured to transfer electro-magnetically propagated communications between said at least one source/originator parties and said at least one destination/auxiliary party and to store transcripts of said transferred communications including at least part of contents of said transferred communications and times associated with said communications, each said transcripts being stored for a period complying with at least one from a group including: permanent storing, storing for as long as required by law, and storing until cessation of storing as agreed upon by all at least one source/originator party and all at least one destination/auxiliary party of communications corresponding to said each said transcripts, and wherein said transcripts can not be modified by any of said at least one source/originator party nor by any of said at least one destination/auxiliary party while stored;
said each said transcripts being configured to serve as evidence in the case of a dispute involving at least one party from a group including: said at least one source/originator party and said at least one destination/auxiliary party of communications corresponding to said each said transcripts.

59. The system of claim 58, wherein said intermediary is a server, said at least one source is an HTTP server, and said at least one destination is a client browser.

60. The system of claim 58, wherein said at least one source is a fax machine, said at least one destination is a fax machine and said communications are transferred by fax

61. The system of claim 58, wherein said at least one originator party and said at least one auxiliary party are configured to connect to one another in a multi-party call including said intermediary.

62. The system of claim 58, further comprising:
at least one diverter between said at least one source/originator party and said intermediary, configured to divert said electro-magnetically propagated communications for said at least one destination/auxiliary party from said at least one source/originator party to said intermediary.

63. The system of claim 62, wherein said at least one source is a fax machine, said at least one destination is a fax machine and said communications are transferred by fax

64. The system of claim 62, wherein said at least one source is an email client, said at least one diverter shares a unit with said at least one source, and said at least one destination is an email client.

65. The system of claim 62, wherein said intermediary is a proxy server for said at least one source, said at least one source is a client browser, and said at least one diverter shares a unit with said at least one source.

66. The system of claim 62, wherein said at least one originator party is connected to an Ethernet cable in line with said at least one diverter.

67. The system of claim 62, wherein said at least one originator party and said at least one auxiliary party are configured to connect to one another in a multi-party call including said intermediary.

68. A system for authenticating communications, comprising:
at least one source/originator party;
at least one destination/auxiliary party;
an intermediary; and
at least one diverter between said at least one source/originator party and said intermediary, configured to divert communications for said at least one destinations/auxiliary parties from said at least one source/originator party to said intermediary,
wherein said intermediary is configured to transfer said communications between said at least one source/originator parties and said at least one destination/auxiliary party and to store transcripts of said transferred communications including at least part of contents of said transferred communications and times associated with said communications, each said transcripts being stored for a period complying with at least one from a group including: permanent storing, storing for as long as required by law, and storing until cessation of storing as agreed upon by all at least one source/originator party and all at least one destination/auxiliary party of communications corresponding to said each said transcripts, and said transcripts can not be modified by any of said at least one source/originator party nor by any of said at least one destination/auxiliary party while stored; said each said transcripts being configured to serve as evidence in the case of a dispute involving at least one party from a group including: said at least one source/originator party and said at least one destination/auxiliary party of communications corresponding to said each said transcripts.

69. The system of claim 68, wherein said at least one diverter is a regular courier/post office or processing center, said intermediary is a secure processing center and said communications are transferred between said at least one source and said at least one destination by courier or mail.

70. A program storage device readable by machine, tangibly embodying a program of instructions executable by the machine to perform method steps for authenticating electro-magnetically propagated communications, comprising the steps of:
receiving at least one electro-magnetically communication from at least one sender which is intended for at least one recipient;
transferring said at least one communication to said at least one recipient; and
storing a transcript including at least part of a content of said at least one communication and a time associated with said at least one communication;
wherein a period of said storing complies with at least one from a group including: permanent storing, storing for as long as required by law, and storing until cessation of storing as agreed upon by all said at least one sender and all said at least one recipient; and
wherein during said period of said storing, said transcript can not be modified by any of said at least one sender nor by any of said at least one recipient.

71. A computer program product comprising a computer useable medium having computer readable program code embodied therein for authenticating electro-magnetically propagated communications, the computer program product comprising:
computer readable program code for causing the computer to receive at least one electro-magnetically communication from at least one sender which is intended for at least one recipient;
computer readable program code for causing the computer to transfer said at least one communication to said at least one recipient; and
computer readable program code for causing the computer to store a transcript including at least part of a content of said at least one communication and a time associated with said at least one communication;
wherein a period of said storing complies with at least one from a group including: permanent storing, storing for as long as required by law, and storing until cessation of storing as agreed upon by all said at least one sender and all said at least one recipient; and
wherein during said period of said storing, said transcript can not be modified by any of said at least one sender nor by any of said at least one recipient.

72. A program storage device readable by machine, tangibly embodying a program of instructions executable by the machine to perform method steps for authenticating electro-magnetically propagated communications, comprising the steps of:
receiving at least one electro-magnetically communication from at least one sender which is intended for at least one recipient;
transferring said at least one communication to said at least one recipient; and
storing a transcript including at least part of a content of said at least one communication and a time associated with said at least one communication; said transcript being configured to serve as evidence in the case of a dispute involving at least one party from a group including: said at least one sender and said at least one recipient;
wherein a period of said storing complies with at least one from a group including: permanent storing, storing for as long as required by law, and storing until cessation of storing as agreed upon by all said at least one sender and all said at least one recipient; and
wherein during said period of said storing, said transcript can not be modified by any of said at least one sender nor by any of said at least one recipient.

73. A computer program product comprising a computer useable medium having computer readable program code embodied therein for authenticating electro-magnetically propagated communications, the computer program product comprising:
computer readable program code for causing the computer to receive at least one electro-magnetically communication from at least one sender which is intended for at least one recipient;
computer readable program code for causing the computer to transfer said at least one communication to said at least one recipient; and
computer readable program code for causing the computer to store a transcript including at least part of a content of said at least one communication and a time associated with said at least one communication; said transcript being configured to serve as evidence in the case of a dispute including at least one party from a group including: said at least one sender and said at least one recipient;
wherein a period of said storing complies with at least one from a group including: permanent storing, storing for as long as required by law, and storing until cessation of storing as agreed upon by all said at least one sender and all said at least one recipient; and
wherein during said period of said storing, said transcript can not be modified by any of said at least one sender nor by any of said at least one recipient.

74. A program storage device readable by machine, tangibly embodying a program of instructions executable by the machine to perform method steps for providing authentication of electro-magnetically propagated communications, comprising the steps of:
receiving an inquiry from an inquirer about at least one electro-magnetically propagated communication which involved a trusted intermediary;
retrieving a transcript stored by said intermediary, said transcript including at least part of a content of said at least one communication and a time associated with said at least one communication; and
transferring said transcript to said inquirer; wherein said transferred transcript is used as evidence in a dispute involving at least one party from a group including: at least one sender and at least one recipient of at least one of said at least one communication;
wherein said stored transcript was stored for a period complying with at least one from the group including: permanent storing, storing for as long as required by law, and storing until cessation of storing as agreed upon by all said at least one sender and all said at least one recipient, and wherein during said period of storing, said transcript could not be modified by any of said at least one sender nor by any of said at least one recipient.

75. A computer program product comprising a computer useable medium having computer readable program code embodied therein for providing authentication of electro-magnetically propagated communications, the computer program product comprising:
computer readable program code for causing the computer to receive an inquiry from an inquirer about at least one electro-magnetically propagated communication which involving a trusted intermediary;
computer readable program code for causing the computer to retrieve a transcript stored by said intermediary, said transcript including at least part of a content of said at least one communication and a time associated with said at least one communication; and
computer readable program code for causing the computer to transfer said transcript to said inquirer; wherein said transferred transcript is used as evidence in a dispute involving at least one party from a group including: at least one sender and at least one recipient of at least one of said at least one communication;
wherein said stored transcript was stored for a period complying with at least one from the group including: permanent storing, storing for as long as required by law, and storing until cessation of storing as agreed upon by all said at least one sender and all said at least one recipient, and wherein during said period of storing, said transcript could not be modified by any of said at least one sender nor by any of said at least one recipient.

76. A program storage device readable by machine, tangibly embodying a program of instructions executable by the machine to perform method steps for diverting electro-magnetically propagated communications for authentication, comprising the steps of:
receiving at least one electro-magnetically propagated communication from at least one sender which is intended for at least one recipient; and
transferring said at least one communication to an intermediary,
wherein said intermediary authenticates said at least one communication by an authenticating process including storing a transcript including at least part of a content of said at least one communication and a time associated with said at least one communication for a storing period complying with at least one from a group including: permanent storing, storing for as long as required by law, and storing until cessation of storing as agreed upon by all said at least one sender and all said at least one recipient, and wherein during said storing period said transcript can not be modified by any of said at least one sender nor by any of said at least one recipient.

77. A computer program product comprising a computer useable medium having computer readable program code embodied therein for diverting electro-magnetically propagated communications for authentication, the computer program product comprising:
computer readable program code for causing the computer to receive at least one electro-magnetically propagated communication from at least one sender which is intended for at least one recipient; and
computer readable program code for causing the computer to transfer said at least one communication to an intermediary;
wherein said intermediary authenticates said at least one communication by an authenticating process including storing a transcript including at least part of a content of said at least one communication and a time associated with said at least one communication for a storing period complying with at least one from a group including: permanent storing, storing for as long as required by law, and storing until cessation of storing as agreed upon by all said at least one sender and all said at least one recipient, and wherein during said storing period said transcript can not be modified by any of said at least one sender nor by any of said at least one recipient.
